(19) United States
(12) Patent Application Publication
(10) Pub. No.: US 2026/0268858 A1
(43) Pub. Date: Sep. 10, 2026

(54) DISPLAY DEVICE AND ELECTRONIC DEVICE

(71) Applicant: SAMSUNG DISPLAY CO., LTD., YONGIN-SI (KR)

(72) Inventors: Kang Bin JO, Yongin-si (KR); Seung Hyun MOON, Yongin-si (KR); Gyeong Ub MOON, Yongin-si (KR); Go Eun CHA, Yongin-si (KR); Bo Ram CHOI, Yongin-si (KR)

(21) Appl. No.: 19/557,252

(22) Filed: Mar. 5, 2026

(30) Foreign Application Priority Data
Mar. 5, 2025 (KR) 10-2025-0028462
Oct. 10, 2025 (KR) 10-2025-0146015

(51) Int. Cl. G09G 3/3266

(52) U.S. Cl. CPC G09G 3/3266; G09G 2310/08; G09G 2330/021; G09G 2354/00; G09G 2360/148

(57) ABSTRACT

The present disclosure relates to a display device, and more particularly, to a display device and an electronic device capable of reducing a sensing time for a touch input. According to an aspect of the present disclosure, a display device includes a display panel comprising a display area and a non-display area, a plurality of pixels and a plurality of optical sensors disposed in the display area, a plurality of light emitting elements, a scan driver connected to the plurality of pixels and the plurality of optical sensors, a readout circuit connected to the plurality of optical sensors through a plurality of readout lines, and an optical sensor driver connected to the plurality of optical sensors and sequentially outputting a plurality of scan read signals to supply the scan read signals to the plurality of optical sensors in sequence, wherein the optical sensor driver provides the scan read signals sequentially to the optical sensors from an upper side of the display area to a lower side of the display area, and the readout circuit reads out detection voltages from the plurality of optical sensors through readout lines during a readout period in which the scan read signals are supplied to the optical sensors correspond to a touch input applied to the display area.

### CROSS-REFERENCE TO RELATED APPLICATION

This application claims priority to Korean Patent Applications Nos. 10-2025-0028462 filed on Mar. 5, 2025 and 10-2025-0146015 filed on Oct. 10, 2025 in the Korean Intellectual Property Office, and all the benefits accruing therefrom under 35 U.S.C. 119, the contents of which are incorporated by reference herein in their entirety.

### Technical Field

The present disclosure relates to a display device, and more particularly, to a display device and an electronic device capable of reducing a sensing time for a touch input.

### Discussion of the Related Art

An organic light emitting display device includes a display element of which luminance is changed by a current, for example, an organic light emitting diode.

### SUMMARY

Aspects of the present disclosure provide a display device and an electronic device capable of reducing a sensing time for sensing a touch input.

According to an aspect of the present disclosure, a display device includes a display panel comprising a display area and a non-display area, a plurality of pixels and a plurality of optical sensors disposed in the display area, each of the plurality of pixels including a light emitting element and each of the plurality of optical sensors including a photoelectric conversion element, a scan driver configured to provide a plurality of scan signals to the plurality of pixels and the plurality of optical sensors through a plurality of scan lines, a readout circuit connected to the plurality of optical sensors through a plurality of readout lines, and an optical sensor driver configured to sequentially provide a plurality of scan read signals to the plurality of optical sensors from an upper side of the display area to a lower side of the display area through a plurality of scan read lines. During a readout period, the readout circuit reads out detection voltages from the plurality of optical sensor through the plurality of readout lines while the optical sensor driver supplies the scan read signals to optical sensors corresponding to a touch input applied to the display area.

According to an aspect of the present disclosure, an electronic device includes a processor, and a display device providing a display screen. The display device includes a display panel comprising a display area and a non-display area, a plurality of pixels and a plurality of optical sensors located in the display area, a plurality of light emitting elements included in the plurality of pixels, a scan driver connected to the plurality of pixels and the plurality of optical sensors, a readout circuit connected to the plurality of optical sensors through a plurality of readout lines, and an optical sensor driver connected to the plurality of optical sensors and sequentially outputting a plurality of scan read signals to supply the scan read signals to the plurality of optical sensors. The optical sensor driver provides the scan read signals sequentially to the optical sensors from an upper side of the display area to a lower side of the display area. The readout circuit generates digital sensing data based on detection voltages detected from the plurality of optical sensors through the plurality of readout lines during a readout period while the scan read signals are supplied to optical sensors corresponding to a touch input applied to the display area, and transmit the digital sensing data to the processor.

The processor analyzes the digital sensing data to determine whether the digital sensing data matches a pre-registered user's fingerprint, and when the pre-registered fingerprint and the digital sensing data received from the readout circuit matches, the processor performs preset functions.

According to an embodiment of the display device and the electronic device, the sensing time for sensing a touch input may be reduced.

For example, according to one embodiment, optical sensors may be independently controlled by a separate scan read signal rather than by a scan signal outputted from an optical scan driver. Therefore, the optical sensors may be activated freely without being constrained by the driving time of pixels. Consequently, even if the driving time of the pixels and the driving time of the optical sensors are different, a readout circuit may read out data (e.g., a detection voltage) from the optical sensors without a time delay due to the deviation between the driving times of the pixels and the optical sensors. Therefore, sensing latency due to the deviation in driving times between the pixels and the optical sensors may be minimized.

### BRIEF DESCRIPTION OF THE DRAWINGS

The above and other aspects and features of the present disclosure will become more apparent from the following detailed description of exemplary embodiments, taken in conjunction with the accompanying drawings, in which:

FIG. 1 is a plan view illustrating a display device 1 according to one embodiment;

FIG. 2 is a block diagram of a display device according to one embodiment;

FIG. 3 is a cross-sectional view schematically illustrating the active region of the display device according to one embodiment, and a method for sensing a fingerprint of a finger;

FIG. 4 is a cross-sectional view schematically illustrating the active region of the display device according to one embodiment, and a method for sensing a fingerprint of a finger;

FIG. 5 is a circuit diagram illustrating a pixel and an optical sensor according to one embodiment;

FIG. 6 is a diagram illustrating the placement of the optical sensor driver of the display device according to one embodiment;

FIG. 7 is a diagram illustrating the placement of the optical sensor driver of the display device according to one embodiment;

FIG. 8 is a view illustrating the placement of the optical sensor driver of the display device according to one embodiment;

FIG. 9 is a diagram illustrating the placement of the optical sensor driver of the display device according to one embodiment;

FIGS. 10 and 11 are views illustrating the operation of the display device according to one embodiment when a touch input is located at a lower side of the display area;

FIGS. 12 and 13 are views illustrating the operation of the display device according to one embodiment when a touch input is located at the upper side of the display area;

FIGS. 14 and 15 are views illustrating the operation of the display device according to one embodiment when a touch input is located in the second sub-display area;

FIGS. 16 and 17 are views illustrating the operation of the display device according to one embodiment when a touch input is located in the first sub-display area;

FIG. 18 and FIG. 19 are views illustrating the operation of the display device according to one embodiment when a touch input is located at an area that overlaps the interface between the first sub-display area and the second sub-display area;

FIG. 20 and FIG. 21 are views illustrating the operation of the display device according to one embodiment when a touch input is located at the lower side of the display area;

FIG. 22 illustrates a display device according to one embodiment;

FIG. 23 is an enlarged view of area A of FIG. 22;

FIG. 24 illustrates the output of the scan read signal in accordance with a carry control signal of FIG. 23;

FIG. 25 is a block diagram of an electronic device according to one embodiment; and

FIGS. 26, 27 and 28 are schematic views illustrating electronic devices according to various embodiments.

### DETAILED DESCRIPTION OF EMBODIMENTS

The present invention will now be described more fully hereinafter with reference to the accompanying drawings, in which exemplary embodiments of the disclosure are shown. This disclosure may, however, be embodied in different forms and should not be construed as limited to the embodiments set forth herein. Rather, these embodiments are provided so that this disclosure will be thorough and complete, and will fully convey the scope of the invention to those skilled in the art.

It will be understood that when a layer is referred to as being “on” another layer or substrate, it can be directly on the other layer or substrate, or intervening layers may also be present. The same reference numbers indicate the same components throughout the specification. In the attached figures, the thickness of layers and regions is exaggerated for clarity.

Although the terms “first”, “second”, and the like may be used herein to describe various elements, such elements should not be limited by these terms. These terms may be used to distinguish one element from another element. Thus, a first element discussed below may be referred to as a second element without departing from the teachings of one or more embodiments. The description of an element as a “first” element may not require or imply the presence of a second element or other elements. The terms “first”, “second”, and the like may also be used herein to differentiate different categories or sets of elements. For conciseness, the terms “first”, “second”, and the like may represent “first-category (or first-set)”, “second-category (or second-set)”, and so forth, respectively.

Features of various embodiments of the present disclosure may be combined partially or totally. As will be clearly appreciated by those skilled in the art, technically various interactions and operations are possible. Various embodiments can be practiced individually or in combination.

Hereinafter, specific exemplary embodiments will be described with reference to the accompanying drawings.

A display device may include a display panel, a scan driver, and an optical sensor driver. The display panel includes a plurality of pixels and a plurality of optical sensors. The scan driver provides scan signals to the plurality of pixels and the plurality of optical sensors for light emitting operation of the pixels and pre-sensing operation of the optical sensors. The optical sensor driver provides scan read signals to the optical sensors to perform an optical sensing operation for reading out detection voltages from the optical sensors. In comparative display devices, since the light emitted from the pixels is used for the optical sensing operation, a timing difference between the light emitting operation of the pixels and the optical sensing operation of the optical sensors may limit the speed of optical sensing operation. According to the present disclosure, the optical sensor driver independently controls timing of the optical sensing operation depending on a location of the touch input, thereby enhancing the speed of the optical sensing operation. Furthermore, as the display device may activate only the optical sensors corresponding to the touch input, power consumption may be reduced.

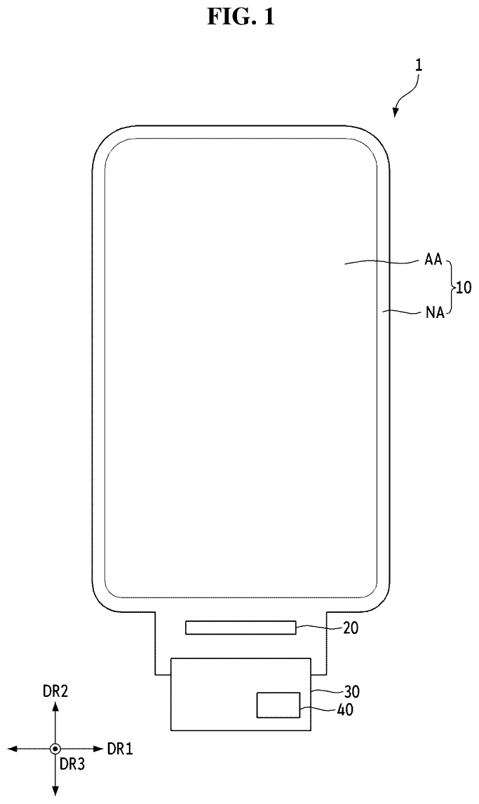

FIG. 1 is a plan view illustrating a display device 1 according to one embodiment.

In FIG. 1, a first direction DR1, a second direction DR2, and a third direction DR3 are indicated. The first direction DR1 may be a direction parallel to one side of the display device 1 in plan view and may correspond, for example, to a horizontal direction of the display device 1. The second direction DR2 may be a direction parallel to the other side of the display device 1 in plan view and may correspond, for example, to a vertical direction of the display device 1. The third direction DR3 may be a thickness direction (or height direction) of the display device 1. However, a direction mentioned in the following embodiments may refer to a relative direction, and the embodiments are not limited thereto.

Further, in the embodiments, the term “above” or “top surface” expressed with respect to the third direction DR3 may refer to a display surface side of a display panel 10, and the term “below,” “bottom surface,” or “rear surface” may refer to a side opposite to the display surface of the display panel 10. However, according to the direction facing the display panel 10 or the display device 1 including the same, the defined direction may be changed to the opposite direction or the like.

Referring to FIG. 1, the display device 1 may be one of various electronic devices providing a display surface on which an image is displayed. For example, the display device 1 may be one of various electronic devices including a mobile phone, a smart phone, a tablet personal computer (PC), a mobile communication terminal, an electronic notebook, an electronic book, a personal digital assistant (PDA), a portable multimedia player (PMP), a navigation device, an ultra-mobile PC (UMPC), a television, a game console, a wrist watch type electronic device, a head-mounted display, a personal computer monitor, a laptop computer, a car dashboard, a digital camera, a camcorder, an external billboard, an electric billboard, various medical devices, various inspection devices, various home appliances including a display area such as a refrigerator or a washing machine, an Internet-of-Things (IoT) device, and the like. A typical example of the display device 1 to be described later may be a smart phone, a tablet PC, or a laptop computer, but the display device 1 according to the embodiments is not limited thereto.

The display device 1 may include a display panel 10, a driving circuit 20, a circuit board 30, and a readout circuit 40 (e.g., a readout IC).

The display panel 10 may include an active region AA and a non-active region NA. In one embodiment, the display panel 10 may be partially or entirely flexible, and may be configured to be folded, bent, or rolled in at least one portion. For example, the display panel 10 may be folded or bent in the non-active region NA, so that a part of the non-active region NA, on which the driving circuit 20 or the like is mounted, may be positioned on the opposite side (for example, the rear surface side of the display device 1) of the display surface.

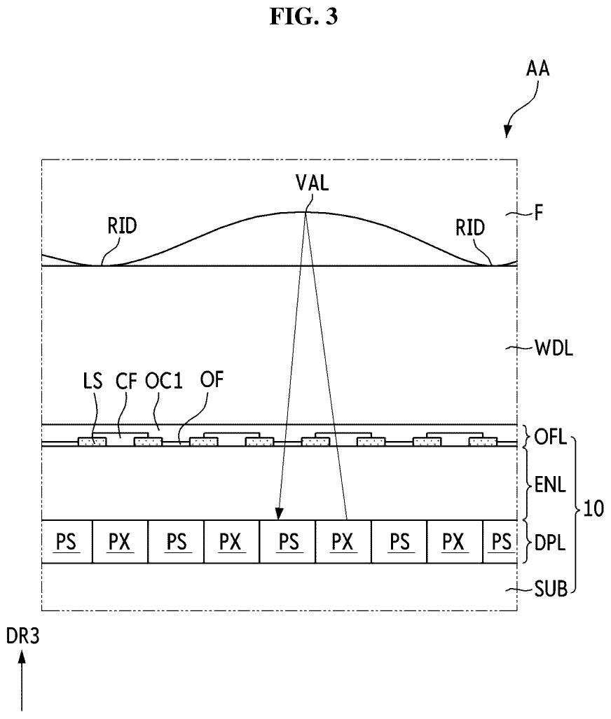

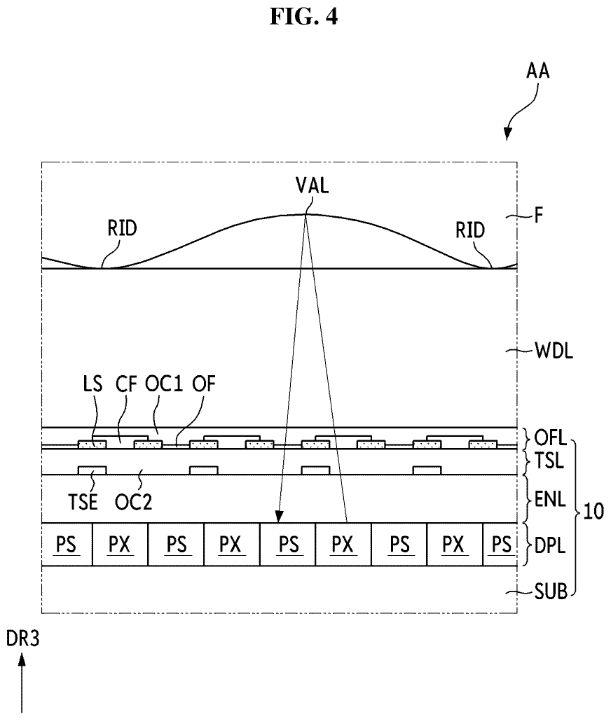

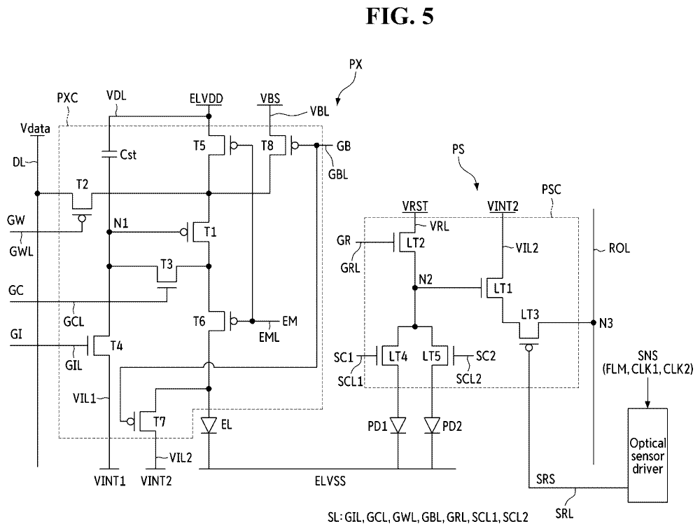

The active region AA may include a display area. For example, the active region AA may completely overlap the display area. Pixels (for example, pixels PX of FIG. 3 or 4) for displaying an image may be located in the active region AA (or the display area). For example, the active region AA may include pixel areas where pixels are arranged or provided. Each pixel area may include an emission area. In one embodiment, a light emitting element (for example, a light emitting element EL of FIG. 5) may be located in each emission area.

The active region AA may further include a sensing area that responds to light. For example, the active region AA may further include a sensing area (for example, a light sensing area) for sensing the amount or wavelength of incident light. In one embodiment, the sensing area may include a fingerprint sensing area for sensing a user's fingerprint using optical sensors. For example, optical sensors (for example, optical sensors PS of FIG. 3 or 4) may be located in the active region AA. Each optical sensor may include a photoelectric conversion element (for example, a photoelectric conversion element PD1 or PD2 of FIG. 5). The photoelectric conversion element may sense incident light and convert it into an electrical signal. The photoelectric conversion elements PD1 and PD2 may alternately operate within a single frame, in which two different clocks having different clock frequencies may be respectively applied to enable the photoelectric conversion elements PD1 and PD2 at different times, such that, by a lternating their operation, the display device may expand a dynamic range, and enable stable detection under both strong and weak light conditions.

For example, the active region AA may include the optical sensors including respective photoelectric conversion elements. The optical sensors may output sensing signals corresponding to incident light, and may sense a user's input (for example, a fingerprint input) provided in the active region AA using the sensing signals.

In one embodiment, the sensing area may correspond to an entire area of the display area. In another embodiment, the sensing area may be a part of the display area. Accordingly, the sensing area may be a part of the active region AA, or may be the entire active region AA of the display area illustrated in FIG. 1.

The non-active region NA may include a non-display area, and may be located around the active region AA. The non-active region NA may be located on at least one side of the active region AA, and may partially or entirely surround the active region AA. Lines, pads, and/or the driving circuit 20 electrically connected to the pixels and/or the optical sensors of the active region AA may be located in the non-active region NA.

The driving circuit 20 may be electrically connected to the pixels and the optical sensors of the active region AA to drive the pixels and the optical sensors. For example, the driving circuit 20 may generate driving signals and/or power voltages for driving the pixels and the optical sensors, and may output the driving signals and/or the power voltages to the pixels and the optical sensors. For example, the driving circuit 20 may include at least one of a gate driving circuit (or a part of the gate driving circuit) including a scan driver or a source driving circuit (or a part of the source driving circuit) including a data driver.

The driving circuit 20 may be formed as an integrated circuit (IC) and mounted on the display panel 10, or may be mounted on the circuit board 30 connected to the display panel 10. In one embodiment, the driving circuit 20 may be disposed outside the active region AA. In another embodiment, at least a part of the driving circuit 20 (for example, at least a part of the scan driver) may be disposed inside the active region AA and may be formed together with pixels.

The circuit board 30 may be connected to or attached to one end of the display panel 10. For example, the circuit board 30 may be attached to one end of the display panel 10 using an anisotropic conductive film (ACF). Lead lines of the circuit board 30 may be electrically connected to a pad portion of the display panel 10. In one embodiment, the circuit board 30 may be implemented as a flexible film, such as a flexible printed circuit board (FPCB) or a chip on film (COF).

The readout circuit 40 may be electrically connected to the optical sensors located in the active region AA. The readout circuit 40 may receive the electrical signal corresponding to the current flowing through the optical sensors. The readout circuit 40 may convert the electrical signal received from the optical sensors and transmit the converted signal to a processor (for example, the processor provided in a host device or the display device 1) connected to the readout circuit 40, or may execute a designated function based on the electrical signal.

In one embodiment, the readout circuit 40 may be formed as an integrated circuit (IC) and attached on the circuit board 30 by a chip on film (COF) method, but the embodiments are not limited thereto. For example, the readout circuit 40 may be attached to the non-active region NA of the display panel 10 by a chip on glass (COG) method, a chip on plastic (COP) method, or an ultrasonic bonding method.

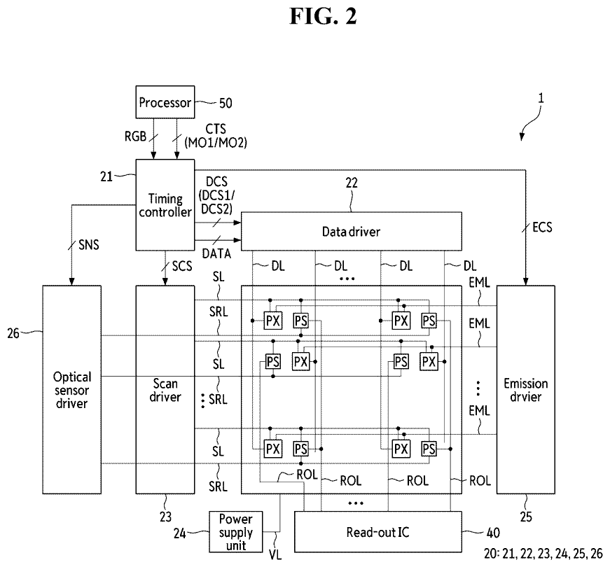

FIG. 2 is a block diagram of a display device according to one embodiment.

Referring to FIG. 2 in addition to FIG. 1, the display device 1 may include the display panel 10, the driving circuit 20, the readout circuit 40, and a processor 50. Although FIG. 2 discloses an embodiment in which the processor 50 is provided in the display device 1, the embodiments are not limited thereto. For example, the processor 50 may be provided in the host device connected to the display device 1.

The display panel 10 may include pixels PX and optical sensors PS arranged in the active region AA, scan lines SL connected to the pixels PX and the optical sensors PS, scan read lines connected to the optical sensors PS, power voltage lines VL connected to the pixels PX and the optical sensors PS, data lines DL and emission control lines EML connected to the pixels PX, and readout lines ROL connected to the optical sensors PS.

Each pixel PX may be connected to at least one scan line SL, one data line DL, one emission control line EML, and at least one power voltage line VL.

Each optical sensor PS may be connected to at least one scan line SL, one scan read line, one readout line ROL, and at least one power voltage line VL. In one embodiment, the optical sensors PS may be disposed between the pixels PX, and may be formed inside the display panel 10 together with the pixels PX. For example, the optical sensors PS and the pixels PX may be alternately arranged in the active region AA.

The scan lines SL may connect the pixels PX and the optical sensors PS to the scan driver 23. The scan driver 23 may provide scan signals to the pixels PX and the optical sensors PS through scan lines SL.

The data lines DL may connect the pixels PX to the data driver 22. The data driver 22 may provide respective data signals to the pixels PX through the data lines DL.

The emission control lines EML may connect the pixels PX to an emission control driver 25. The emission control driver 25 may provide emission control signals to the pixels PX through the emission control lines EML.

The readout lines ROL may connect the optical sensors PS to the readout circuit 40. The readout circuit 40 may detect an electrical signal (for example, sensing currents or sensing signals) generated from the optical sensors PS according to respective photoelectric current to the through the readout lines ROL. Accordingly, the readout circuit 40 may sense a user input (for example, a fingerprint input).

The scan read lines SRL may connect the respective optical sensors PS to an optical sensor driver 26. The optical sensor driver 26 may provide scan read signals to the respective optical sensors PS through the scan read lines SRL. For example, the optical sensor driver 26 may sequentially activate the optical sensors PS from those located at the upper side of the display area AA to those located at the lower side of the display area DA. As a result, the optical sensors PS may be sequentially activated on a horizontal line basis from the upper side of the display area DA to the lower side of the display area DA.

The power voltage lines VL may connect the pixels PX and the optical sensors PS to a power supply unit 24. For example, the power supply unit 24 may provide a first power voltage (for example, a first power voltage ELVDD of FIG. 5), a second power voltage (for example, a second power voltage ELVSS of FIG. 5) and/or other power voltages to the pixels PX and the optical sensors PS through the power voltage lines VL. Although FIG. 2 illustrates that a single power voltage line VL is provided to the display panel 10, two or more power voltage lines VL having different voltage levels, depending on the type and/or number of power voltages used to drive the pixels PX and the optical sensors PS, may be provided to the display panel 10. For example, the first power voltage ELVDD may have a value of 2.8 V, and the second power voltage ELVSS may have a value of −3.5 V.

The driving circuit 20 may include a data driver 22, a scan driver 23, an optical sensor driver 26, and a timing controller 21.

The data driver 22 may provide the pixels PX with data signals through data lines DL.

The scan driver 23 may provide the pixels PX and the optical sensors PS with scan signals through the scan lines SL.

The optical sensor driver 26 may provide the optical sensors PS with the scan read signals SRS through the scan read lines SRL. Accordingly, the optical sensor driver 26 may independently drive the optical sensors PS.

The timing controller 21 may control the driving timings of the data driver 22, the scan driver 23, and the optical sensor driver 26.

In one embodiment, the driving circuit 20 may further include the power supply unit 24 for generating and/or transmitting power voltages for driving the pixels PX and the optical sensors PS, and the emission driver 25 for providing the pixels PX with the emission control signals through the emission control lines EML.

The timing controller 21 may receive an image signal RGB and control signals CTS from the processor 50. The timing controller 21 may output image data DATA, a data control signal DCS, a scan control signal SCS, an emission control driving signal ECS, and an optical sensor control signal SNS based on the image signal RGB and the control signals CTS. The image data DATA and the data control signal DCS may be supplied to the data driver 22. The scan control signal SCS may be supplied to the scan driver 23, the emission control driving signal ECS may be supplied to the emission driver 25, and the optical sensor control signal SNS may be supplied to the optical sensor driver 26.

In one embodiment, the control signals CTS may include a first mode control signal MO1 and a second mode control signal MO2. The timing controller 21 may generate a first data control signal DCS1 in response to the first mode control signal MO1, and may generate a second data control signal DCS2 in response to the second mode control signal MO2.

The data driver 22 may generate data signals corresponding to the image data DATA, and may provide the data signals to the pixels PX through the data lines DL. For example, the data driver 22 may convert the image data DATA into analog data voltages and may provide the converted analog data voltages to the pixels through the data lines DL.

The scan driver 23 may generate scan signals in response to the scan control signal SCS, and may provide the scan signals to the pixels PX through the scan lines SL.

The power supply unit 24 may generate at least one power voltage for driving the pixels PX and the optical sensors PS, and may output the at least one power voltage to the pixels PX and the optical sensors PS through the power voltage line VL.

The emission driver 25 may generate emission control signals in response to the emission control driving signal ECS, and may provide the emission control signals to the piexels PX through the emission control lines EML. The emission driver 25 may be formed or provided separately from the scan driver 23, or may be integrated into the scan driver 23.

The optical sensor driver 26 may generate scan read signals in response to the optical sensor control signal SNS and provide the scan read signals to the optical sensors PS through scan read lines SRL.

The readout circuit 40 may be connected to the optical sensors PS through the readout lines ROL, and may receive an electrical signal (for example, a current flowing through each optical sensor PS) corresponding to the amount of light received by the optical sensors PS. The readout circuit 40 may generate data, for example, digital sensing data, corresponding to the magnitude of the electrical signal received from each optical sensor PS and may transmit it to the processor 50. In the case of sensing a user's fingerprint using the electrical signal from the optical sensors PS, the processor 50 may analyze the digital sensing data to determine whether or not the digital sensing data is the same as a pre-registered user's fingerprint. When the pre-registered fingerprint and the digital sensing data transmitted from the readout circuit 40 are the same, preset functions may be performed.

The processor 50 may be outside the display device and may supply the image signal RGB and the control signals CTS to the timing controller 21 of the display device. The processor 50 may further include a graphic processing unit (GPU) configured to process graphics for the image signal RGB. The image signal RGB, which is an image source that has been subjected to graphic processing in the GPU, may be provided to the timing controller 21. The image signal RGB may have a specific frequency (for example, a frequency of 120 Hz or 30 Hz).

The control signals CTS outputted from the processor 50 may include the first mode control signal MO1, the second mode control signal MO2, a clock signal, an enable signal, and the like. The first mode control signal MO1 may include a display mode signal for displaying a normal image. The second mode control signal MO2 may include a sensing mode signal for sensing a user's fingerprint or the like. In one embodiment, the second mode control signal MO2 may be a signal that causes at least some pixels PX (for example, green pixels) to emit light during a period in which the sensing mode is executed. Accordingly, a user's fingerprint or the like may be sensed while using the pixels PX as a light source.

The processor 50 may supply the first mode control signal MO1 to the timing controller 21 to control the display of an image on the display panel 10. The processor 50 may supply the second mode control signal MO2 to the timing controller 21 to enable an optical sensing operation for sensing a user's fingerprint or the like. The timing controller 21 may drive the pixels PX of the display panel 10 in response to the first mode control signal MO1. The timing controller 21 may drive both the pixels PX and the optical sensors PS of the display panel 10 in response to the second mode control signal MO2.

FIG. 3 is a cross-sectional view schematically showing the active region AA of the display device 1 according to one embodiment, and illustrating a method for sensing a fingerprint of a finger F. FIG. 3 illustrates the method for sensing the fingerprint of the finger F located on the first active region AA of the display device 1.

Referring to FIG. 3 together with FIGS. 1 and 2, the display device 1 may include the display panel 10, and a window layer WDL disposed on the display panel 10. The display panel 10 may include a substrate SUB, a display layer DPL disposed on the substrate SUB, and an encapsulation layer ENL and an optical filter layer OFL disposed on the display layer DPL.

The substrate SUB may serve as a base member for forming or arranging components of the display panel 10. The substrate SUB may include the active region AA and the non-active region NA. For example, a portion of the substrate SUB may be defined as the active region AA, while another portion of the substrate SUB may be defined as the non-active region NA.

The display layer DPL may include the pixels PX and the optical sensors PS disposed on the substrate SUB. The pixels PX and the optical sensors PS may be formed on the substrate SUB to be located in the active region AA.

For simplicity, FIG. 3 illustrates an embodiment in which the pixels PX and the optical sensors PS are alternately arranged one by one along at least one direction (for example, the first direction DR1 and/or the second direction DR2 intersecting the first direction DR1). However, the arrangement structure, number, and/or resolution of the pixels PX and the optical sensors PS may be variously modified according to embodiments.

In one embodiment, the pixels PX and the optical sensors PS may be formed simultaneously. For example, after a pixel circuit (for example, a pixel circuit PXC of FIG. 5) of each of the pixels PX and an optical sensor circuit (for example, an optical sensor circuit PSC of FIG. 5) of each of the optical sensors PS are simultaneously formed on the substrate SUB, a light emitting element (for example, the light emitting element EL of FIG. 5) of each of the pixels PX and a photoelectric conversion element (for example, the photoelectric conversion element PD1 or PD2 of FIG. 5) of each of the optical sensors PS (or at least a part of the light emitting element EL and at least a part of the photoelectric conversion element) may be simultaneously formed on the substrate SUB on which the pixel circuit and the optical sensor circuit are formed.

As in the embodiment, the display device 1 in which the optical sensors PS are formed inside the display panel 10 together with the pixels PX may have a reduced thickness compared to a comparative display device in which optical sensors are separately provided or attached on one side of a display panel. Furthermore, the display device 1 according to the embodiment may increase the amount of light received by the optical sensors PS compared to the comparative display device.

The encapsulation layer ENL may be disposed or formed on the display layer DPL to cover at least the pixels PX and the optical sensors PS. The encapsulation layer ENL may protect the pixels PX and the optical sensors PS.

The optical filter layer OFL may be disposed above the pixels PX and the optical sensors PS. For example, the optical filter layer OFL may be disposed on the encapsulation layer ENL. The optical filter layer OFL may include a light blocking member LS, color filters CF, and optical filters OF. In one embodiment, the optical filter layer OFL may further include a first overcoat layer OC1 covering the light blocking member LS, the color filters CF, and the optical filters OF.

The light blocking member LS may be disposed above the display layer DPL (for example, above the encapsulation layer ENL covering the display layer DPL) to be located between the pixels PX and the optical sensors PS and/or at their boundary. The light blocking member LS may include openings exposing at least a part of the pixels PX (for example, a light emitting unit or an emission area of each of the pixels PX). Furthermore, the light blocking member LS may include openings exposing at least a portion of the optical sensors PS (for example, a light receiving unit or a light receiving area of each of the optical sensors PS).

The color filters CF may be provided in the active region AA to overlap the pixels PX. For example, the color filters CF corresponding to the colors and/or wavelength bands of lights emitted from the pixels PX may be located above the pixels PX.

The optical filters OF may be provided in the active region AA to overlap the optical sensors PS. For example, the optical filters OF may be disposed above the optical sensors PS. In one embodiment, the optical filters OF may be thin films having thicknesses smaller than those of the color filters CF disposed on the pixels PX. In another embodiment, the optical filters OF may be thin films having thicknesses smaller than that of the light blocking member LS. For example, each optical filter OF may have a further reduced or minimized thickness to satisfy a target transmittance range for light of a specific wavelength band, including a wavelength band of light used for light sensing in each optical sensor PS.

Each of the optical filters OF, which transmits light of some wavelength bands (for example, visible light such as green light emitted from at least some of the pixels PX) while blocking short-wavelength light (for example, short-wavelength external light having wavelength band of 300 nm or 350 nm or less, including ultraviolet rays or the like), may be implemented as a metal thin film or a color filter of a specific color. The optical filter OF has a thickness smaller than that of the color filters CF disposed on the pixels PX, and thus may exhibit higher light transmittance to visible light or the like. For example, since the thickness of the optical filter OF is reduced, the amount (or ratio) of reflected light absorbed by the optical filter OF may be reduced and the amount of light received by the optical sensors PS may be increased. Consequently, the amount of reflected light required for sensing fingerprint input or the like may be decreased.

A window layer WDL may be disposed above the display panel 10 to protect the display panel 10. For example, the window layer WDL may be provided on the display surface of the display panel 10.

When the user's finger F (for example, a part of the finger F including a fingerprint region) is in contact with (or approaches) the top surface of the window layer WDL, light emitted from the pixels PX of the display panel 10 may be reflected from ridges RID of the finger F and valleys VAL between the ridges RID. The portions corresponding to the ridges RID of the finger F may be in contact with the top surface of the window WDL, whereas the portions corresponding to the valleys VAL of the finger F may not be in contact with the window WDL. Accordingly, the top surface of the window layer WDL may be in contact with air at the portions corresponding to the valleys VAL of the finger F.

Since the refractive index of the finger F is different from the refractive index of air, the amount of light reflected from the ridges RID and the amount of light reflected from the valleys VAL may be different. Accordingly, the shape of the fingerprint formed on the finger F may be obtained based on the difference in the amount of light received by the optical sensors PS with respect to the reflected light reflected from the finger F. For example, each optical sensor PS may output an electrical signal corresponding to the amount of received light, and may sense or identify the shape of the fingerprint formed on the finger F using the electrical signals outputted from the optical sensors PS.

FIG. 4 is a cross-sectional view schematically showing the active region AA of the display device 1 according to one embodiment, and illustrating a method for sensing a fingerprint of the finger F.

Referring to FIG. 4 together with FIGS. 1 to 3, the display device 1 may further include a touch sensor layer TSL. In one embodiment, the touch sensor layer TSL may be provided or formed inside the display panel 10. For example, the touch sensor layer TSL may be disposed between the encapsulation layer ENL and the optical filter layer OFL, and may be formed directly on the encapsulation layer ENL. The position of the touch sensor layer TSL may vary according to embodiments.

The touch sensor layer TSL may include sensing patterns TSE (for example, touch electrodes for generating an electrical signal according to a touch input) for sensing a user's touch input, and a second overcoat layer OC2 covering the sensing patterns TSE. The type, structure, and material of the sensing patterns TSE included in the touch sensor layer TSL may be variously modified according to embodiments.

The display device 1 may sense a user's touch input provided to the display surface side (for example, the top surface of the window layer WDL) using the touch sensor layer TSL. The other components of the display device 1 according to the embodiment of FIG. 4 and the method for sensing a fingerprint of the finger F using the optical sensors PS are substantially similar to or the same as those of the display device 1 according to the embodiment of FIG. 3, and therefore a detailed description thereof will be omitted.

FIG. 5 is a circuit diagram of the pixel PX and the optical sensor PS according to one embodiment.

FIG. 5 illustrates an embodiment in which the scan lines SL connected to the pixels PX include a scan initialization line GIL, a scan compensation line GCL, a scan write line GWL, and a scan bias line GBL.

In one embodiment, the scan lines SL may further include a scan reset line GRL, a first scan control line SCL1, and a second scan control line SCL2, each connected to at least one optical sensor PS.

In one embodiment, the scan reset line GRL may receive a scan reset signal GR. In one embodiment, the scan reset signal GR may be simultaneously applied to the optical sensors PS arranged in the active region AA, so that the optical sensors PS can be reset simultaneously.

In one embodiment, the first scan control line SCL1 may receive a first scan control signal SC1. In one embodiment, the first scan control signal SC1 may be simultaneously applied to the optical sensors PS arranged in the active region AA. An electrical signal may be detected from the first photoelectric conversion element PD1 of each optical sensor PS in response to the first scan control signal SC1.

In one embodiment, the second scan control line SCL2 may receive a second scan control signal SC2. In one embodiment, the second scan control signal SC2 may be simultaneously applied to the optical sensors PS arranged in the active region AA. At this time, the second scan control signal SC2 and the first scan control signal SC1 may be applied at different timings. For example, when the second scan control signal SC2 has an active level, the first scan control signal SC1 may have a non-active level. An electrical signal may be detected from the second photoelectric conversion element PD2 of each optical sensor PS in response to the second scan control signal SC2.

According to one embodiment, the scan reset signal GR, the first scan control signal SC1, and the second scan control signal SC2 may be provided from the timing controller 21 instead of the scan driver 23.

According to one embodiment, the scan reset signal GR, the first scan control signal SC1, and the second scan control signal SC2 may be provided from the readout circuit 40 instead of the scan driver 23.

Referring to FIG. 5 together with FIGS. 1 to 4, the pixel PX may include the light emitting element EL and the pixel circuit PXC (or a pixel driver) connected to the light emitting element EL.

The light emitting element EL, which serves as a light source of the pixel PX, may emit light in response to a driving current supplied from the pixel circuit PXC. As the driving current increases, the light emitting element EL may emit light with increased luminance.

In one embodiment, the light emitting element EL may be an organic light emitting diode, but is not limited thereto. For example, the light emitting element EL may be an inorganic light emitting element, a quantum dot light emitting element, or another type of light emitting element.

The pixel circuit PXC may control the light emitting timing and luminance of the light emitting element EL by controlling magnitude of the driving current supplied to the light emitting element EL. The pixel circuit PXC may include a driving transistor, a switching transistor, and a capacitor Cst. In one embodiment, the driving transistor may be implemented as a first transistor T1, and the switching transistor may include second to eighth transistors T2, T3, T4, T5, T6, T7, and T8.

The first transistor T1 may include a gate electrode, a first electrode, and a second electrode. One of the first electrode and the second electrode of the first transistor T1 may be a source electrode and the other may be a drain electrode. The first transistor T1 may control a drain-source current (hereinafter, referred to as “driving current”) flowing between the first electrode and the second electrode according to a voltage of the data signal applied to the gate electrode.

The second transistor T2 may include a gate electrode connected to the scan write line GWL, a first electrode connected to the data line DL, and a second electrode connected to the first electrode of the first transistor T1. One of the first electrode and the second electrode of the second transistor T2 may be a source electrode and the other may be a drain electrode. The second transistor T2 may be turned on by a scan write signal GW supplied to the scan write line GWL to connect the first electrode of the first transistor T1 to the data line DL. When the second transistor T2 is turned on, the voltage of the data signal supplied to the data line DL may be applied to the first electrode of the first transistor T1.

The third transistor T3 may include a gate electrode connected to the scan compensation line GCL, a first electrode connected to the second electrode of the first transistor T1, and a second electrode connected to a gate electrode (or the first node N1) of the first transistor T1. One of the first electrode and the second electrode of the third transistor T3 may be a source electrode and the other may be a drain electrode. The third transistor T3 may be turned on by a scan compensation signal GC supplied to the scan compensation line GCL to connect the gate electrode and the second electrode of the first transistor T1 in a diode configuration. When the third transistor T3 is turned on, the first transistor T1 may operate as a diode.

The fourth transistor T4 may include the gate electrode connected to the scan initialization line GIL, the first electrode connected to the gate electrode of the first transistor T1, and the second electrode connected to the first initialization voltage line VIL1. One of the first electrode and the second electrode of the fourth transistor T4 may be a source electrode and the other may be a drain electrode. The fourth transistor T4 may be turned on by a scan initialization signal GI supplied to the scan initialization line GIL to connect the gate electrode of the first transistor T1 to the first initialization voltage line VIL1. When the fourth transistor T4 is turned on, the first initialization voltage VINT1 of the first initialization voltage line VIL1 may be applied to the gate electrode of the first transistor T1. The first initialization voltage VINT1 may have a value of −2.3 V.

The fifth transistor T5 may include a gate electrode connected to the emission control line EML, a first electrode connected to a first driving voltage line VDL, and a second electrode connected to the first electrode of the first transistor T1. One of the first electrode and the second electrode of the fifth transistor T5 may be a source electrode and the other may be a drain electrode. The fifth transistor T5 may be turned on by the emission control signal EM supplied to the emission control line EML to connect the first electrode of the first transistor T1 to the first driving voltage line VDL to which the first power voltage ELVDD is applied. When the fifth transistor T5 is turned on, the first power voltage ELVDD may be applied to the first electrode of the first transistor T1.

The sixth transistor T6 may include the gate electrode connected to the emission control line EML, the first electrode connected to the second electrode of the first transistor T1, and the second electrode connected to the light emitting element EL. One of the first electrode and the second electrode of the sixth transistor T6 may be a source electrode and the other may be a drain electrode. The sixth transistor T6 may be turned on by the emission control signal EM supplied to the emission control line EML to connect the first transistor T1 to the light emitting element EL. When both the fifth transistor T5 and the sixth transistor T6 are turned on, the driving current having a magnitude corresponding to the voltage of the gate electrode of the first transistor T1 may flow through the light emitting element EL.

The seventh transistor T7 may include the gate electrode connected to the scan bias line GBL, the first electrode connected to the anode electrode of the light emitting element EL, and the second electrode connected to the second initialization voltage line VIL2. One of the first electrode and the second electrode of the seventh transistor T7 may be a source electrode and the other may be a drain electrode. The seventh transistor T7 may be turned on by a scan bias signal GB supplied to the scan bias line GBL to connect the anode electrode of the light emitting element EL to the second initialization voltage line VIL2. When the seventh transistor T7 is turned on, a second initialization voltage VINT2 of the second initialization voltage line VIL2 may be applied to the anode electrode of the light emitting element EL. The second initialization voltage VINT2 may have the same value as the second power voltage ELVSS. For example, the second initialization voltage VINT2 may have a value of −3.5 V. The cathode electrode of the light emitting element EL may be connected to a second driving voltage line VSL. The second driving voltage line VSL may be supplied with the second power voltage ELVSS.

The eighth transistor T8 may include a gate electrode connected to the scan bias line GBL, a first electrode connected to a bias voltage line VBL, and a second electrode connected to the first electrode of the first transistor T1. One of the first electrode and the second electrode of the eighth transistor T8 may be a source electrode and the other may be a drain electrode. The eighth transistor T8 may be turned on by the scan bias signal GB supplied to the scan bias line GBL to connect the first electrode of the first transistor T1 to the bias voltage line VBL. When the eighth transistor T8 is turned on, a bias voltage VBS may be applied to the first electrode of the first transistor T1. The bias voltage VBS may have the same value as the first power voltage ELVDD.

The capacitor Cst may be connected between the gate electrode of the first transistor T1 and the first driving voltage line VDL. The capacitor Cst may store a voltage corresponding to the data signal applied to the gate electrode of the first transistor T1.

In one embodiment, the active layer (e.g., a semiconductor pattern including a channel region) of each of the first to eighth transistors T1, T2, T3, T4, T5, T6, T7, and T8 may include one of polysilicon, amorphous silicon (amorphous Si), and an oxide semiconductor. For example, the active layers of the first transistor T1, the second transistor T2, and the fifth to eighth transistors T5 to T8 may include polysilicon, while the active layers of the third transistor T3 and the fourth transistor T4 may include an oxide semiconductor. In this case, the first transistor T1, the second transistor T2, and the fifth to eighth transistors T5 to T8 may be formed as positive-type (P-type) transistors, whereas the third transistor T3 and the fourth transistor T4 may be formed as negative-type (N-type) transistors.

The optical sensor PS may include the first photoelectric conversion element PD1 (or first light sensing element), the second photoelectric conversion element PD2 (or second light sensing element), and the optical sensor circuit PSC that controls a sensing current according to the photoelectric current of the first photoelectric conversion element PD1 or the second photoelectric conversion element PD2.

The first photoelectric conversion element PD1 may convert externally incident light into an electrical signal. In one embodiment, the first photoelectric conversion element PD may be a photodiode including an anode electrode, a cathode electrode, and a photoelectric conversion layer disposed between the anode electrode and the cathode electrode. In one embodiment, the first photoelectric conversion element PD1 may be implemented as an inorganic photodiode or a phototransistor including a PN type or PIN type inorganic material. Alternatively, the first photoelectric conversion element PD1 may be an organic photodiode including an electron-donating material that generates donor ions and an electron-accepting material that generates acceptor ions.

The second photoelectric conversion element PD2 may be identical to the first photoelectric conversion element PD1 described above.

The first photoelectric conversion element PD1 may be exposed to external light while a fourth sensor transistor LT4 is turned on. Photoelectric charges may be generated and accumulated in the anode electrode of the first photoelectric conversion element PD1, and the accumulated photoelectric charges increase the voltage of the second node N2 electrically connected to the anode electrode of the first photoelectric conversion element PD1. When the first photoelectric conversion element PD1 and the readout line ROL are connected by turning on the first and third sensor transistors LT1 and LT3, a detection voltage may be sensed at a third node N3 between the readout line ROL and the third sensor transistor LT3. The detection voltage may have a value proportional to the voltage of the second node N2 at which the photoelectric charges are accumulated. For example, the detection voltage may have a value of 1 V.

The second photoelectric conversion element PD2 may be exposed to external light while a fifth sensor transistor LT5 is turned on, photoelectric charges may be generated and accumulated in the anode electrode of the second photoelectric conversion element PD2, and the accumulated photoelectric charges increase the voltage of the second node N2 electrically connected to the anode electrode of the second photoelectric conversion element PD2. When the second photoelectric conversion element PD2 and the readout line ROL are connected by the turning on the first and third sensor transistors LT1 and LT3, a detection voltage may be accumulated at the third node N3 between the readout line ROL and the third sensor transistor LT3 in proportion to the voltage of the second node N2 in which the photoelectric charges are accumulated. For example, the detection voltage may have a value of 1 V.

The optical sensor circuit PSC may include sensor transistors for controlling the sensing current generated from the first photoelectric conversion element PD1 or from the second photoelectric conversion element PD2. For example, the optical sensor circuit PSC may include the first to fifth sensor transistors LT1, LT2, LT3, LT4, and LT5.

The first sensor transistor LT1 may include a gate electrode connected to the second node N2, a first electrode connected to the second initialization voltage line VIL2, and a second electrode connected to the first electrode of the third sensor transistor LT3. One of the first electrode and the second electrode of the first sensor transistor LT1 may be a source electrode, and the other may be a drain electrode. The first sensor transistor LT1 may be turned on by the voltage of the second node N2 to connect the second initialization voltage line VIL2 to the first electrode of the third sensor transistor LT3. The first sensor transistor LT1 may be a source follower amplifier that generates a source-drain current proportional to the amount of electric charges accumulated at the second node N2 connected to its gate electrode. FIG. 5 discloses an embodiment in which the first electrode of the first sensor transistor LT1 is connected to the second initialization voltage line VIL2, but the embodiments are not limited thereto. For example, the first electrode of the first sensor transistor LT1 may be connected to the first driving voltage line VDL or the first initialization voltage line VIL1.

The second sensor transistor LT2 may include the gate electrode connected to the scan reset line GRL, the first electrode connected to the reset voltage line VRL, and the second electrode connected to the second node N2. One of the first electrode and the second electrode of the second sensor transistor LT2 may be a source electrode and the other may be a drain electrode. The second sensor transistor LT2 may be turned on by the scan reset signal GR supplied to the scan reset line GRL to connect the reset voltage line VRL to the second node N2. When the second sensor transistor LT2 is turned on, the voltage of the second node N2 may be initialized by the reset voltage VRST.

The third sensor transistor LT3 may include the gate electrode connected to the scan read line, the first electrode connected to the second electrode of the first sensor transistor LT1, and the second electrode connected to the readout line ROL. One of the first electrode and the second electrode of the third sensor transistor LT3 may be a source electrode and the other may be a drain electrode. The third sensor transistor LT3 may be turned on by a first scan read signal supplied to the scan read line to connect the second electrode of the first sensor transistor LT1 and the readout line ROL. When the third sensor transistor LT3 is turned on, the electrical signal corresponding to the photoelectric current flowing through the optical sensor PS may be transmitted to the readout circuit 40 through the readout line ROL.

The fourth sensor transistor LT4 may include a gate electrode connected to the first scan control line SCL1, a first electrode connected to the second node N2, and a second electrode connected to the anode electrode of the first photoelectric conversion element PD1. One of the first electrode and the second electrode of the fourth sensor transistor LT4 may be a source electrode and the other may be a drain electrode. The fourth sensor transistor LT4 may be turned on by the first scan control signal SC1 supplied to the first scan control line SCL1 to connect the anode electrode of the first photoelectric conversion element PD1 to the second node N2. When the fourth sensor transistor LT4 is turned on, the photoelectric charges accumulated in the anode electrode of the first photoelectric conversion element PD1 may be supplied to the second node N2.

The fifth sensor transistor LT5 may include a gate electrode connected to the second scan control line SCL2, a first electrode connected to the second node N2, and a second electrode connected to the anode electrode of the second photoelectric conversion element PD2. One of the first and second electrodes of the fifth sensor transistor LT5 may be a source electrode, and the other may be a drain electrode. The fifth sensor transistor LT5 may be turned on by the second scan control signal SC2 supplied to the second scan control line SCL2 to connect the anode electrode of the second photoelectric conversion element PD2 to the second node N2. When the fifth sensor transistor LT5 is turned on, the photoelectric charges accumulated in the anode electrode of the second photoelectric conversion element PD2 may be supplied to the second node N2.

A scan read signal SRS from the optical sensor driver 26 may be supplied to the third sensor transistor LT3 of the optical sensor PS. For example, the scan read signal SRS from the optical sensor driver 26 may be applied to the gate electrode of the third sensor transistor LT3 through a scan read line SRL.

The optical sensor driver 26 may sequentially output the scan read signals SRS to sequentially supply them to the scan read lines SRL. Accordingly, the optical sensors PS arranged along the vertical direction (for example, the second direction DR2 or the extension direction of the data line) may sequentially receive the scan read signal SRS. As a result, the third sensor transistors LT3 of the optical sensors PS may be sequentially turned on.

The optical sensor driver 26 may sequentially output the scan read signals SRS in response to the optical sensor control signal SNS. The optical sensor control signal SNS may include, for example, a start signal FML, a first clock signal CLK1, and a second clock signal CLK2.

The start signal FML may be outputted twice during a frame period. For example, since one frame period may include a first half frame period and a second half frame period, the aforementioned start signal FML may be outputted once during the first half frame period and once during the second half frame period.

The first clock signal CLK1 may be outputted multiple times during the frame period.

The second clock signal CLK2 may be outputted multiple times during the frame period. The output timing of the second clock signal CLK2 may be different from the output timing of the first clock signal CLK1. For example, the first clock signal CLK1 and the second clock signal CLK2 may be outputted with different phases.

The optical sensor driver 26 may be enabled by the start signal FML to output one of the first and second clock signals CLK1 and CLK2 as the scan read signal SRS. For example, the optical sensor driver 26 may include a plurality of stages that sequentially output the scan read signals SRS. For example, the optical sensor driver 26, in an odd-numbered stage, may output the first clock signal CLK1 as the scan read signal SRS, and in an even-numbered stage, may output the second clock signal CLK2 as the scan read signal SRS. The start signal FML may be supplied to the first stage among the plurality of stages, in which the optical sensor driver 26 starts to output the scan read signals SRS. The n^{th} stage may be enabled by receiving the scan read signal SRS from the (n-1)^{th} stage as a carry signal (e.g., a start signal). The enabled stage may output the scan read signal SRS in synchronization with the corresponding clock signal. The stages may be sequentially enabled, starting from the first stage. Accordingly, the optical sensor driver 26 may sequentially output the scan read signals SRS.

According to one embodiment, as described above, the third sensor transistor LT3 of the optical sensor PS may be independently controlled by the separate scan read signal SRS rather than by the scan signal outputted from the scan driver 23. As a result, the sensing operation of the optical sensors PS may be freely controlled without being constrained by the driving time of the pixels PX.

Therefore, even when the driving time of the pixels PX and the driving time of the optical sensors PS (e.g., readout time of the readout circuit 40) are different from each other, the readout circuit 40 may read out data (e.g., detection voltage) from the optical sensors PS without a time delay caused by the deviation between the driving times of the pixels PX and the optical sensors PS. Accordingly, sensing latency due to the deviation in driving times between the pixels PX and the optical sensors PS may be minimized.

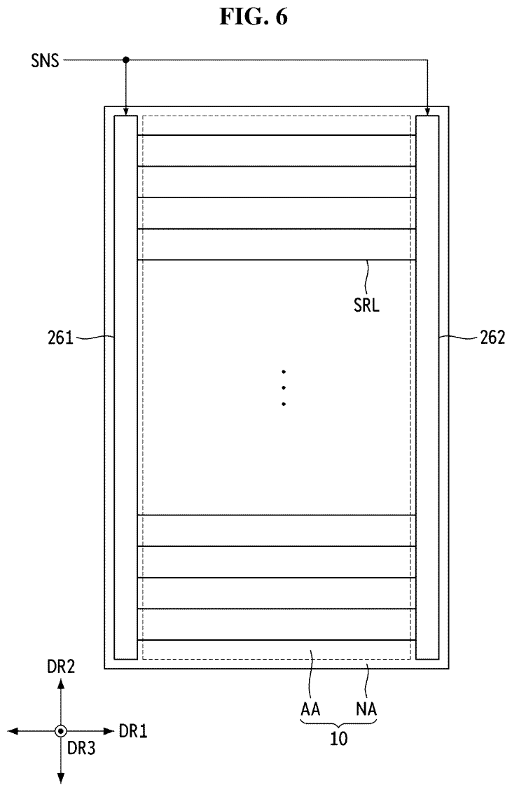

FIG. 6 is a diagram illustrating the placement of the optical sensor driver 26 of the display device 1 according to one embodiment.

As illustrated in FIG. 6, the optical sensor driver 26 may be provided in plurality. For example, the optical sensor driver 26 may include a first optical sensor driver 261 and a second optical sensor driver 262.

The first optical sensor driver 261 may be located in the non-display area NA between one edge of the display panel 10 and one edge of the display area AA, which face each other in the first direction DR1. The first optical sensor driver 261 may be connected to the scan read lines SRL. For example, the first optical sensor driver 261 may be connected to one side of the scan read lines SRL.

The second optical sensor driver 262 may be located in the non-display area NA between the other edge of the display panel 10 and the other edge of the display area AA, which face each other in the first direction DR1. The second optical sensor driver 262 may be connected to the scan read lines SRL. For example, the second optical sensor driver 262 may be connected to the other side of the scan read lines SRL.

The display area AA may be located between the first optical sensor driver 261 and the second optical sensor driver 262.

The first optical sensor driver 261 may sequentially output scan read signals SRS to sequentially supply them to the scan read lines SRL.

The second optical sensor driver 262 may sequentially output the scan read signals SRS to sequentially supply them to the scan read lines SRL.

The first optical sensor driver 261 and the second optical sensor driver 262 may output the scan read signals SRS having the same output timing. For example, when one of the multiple scan read lines SRL is defined as a first scan read line, the scan read signal SRS provided from the first optical sensor driver 261 to one side of the first scan read line and the scan read signal SRS provided from the second optical sensor driver 262 to the other side of the first scan read line may have the same output timing. To this end, the first optical sensor driver 261 and the second optical sensor driver 262 may receive the same optical sensor control signal SNS.

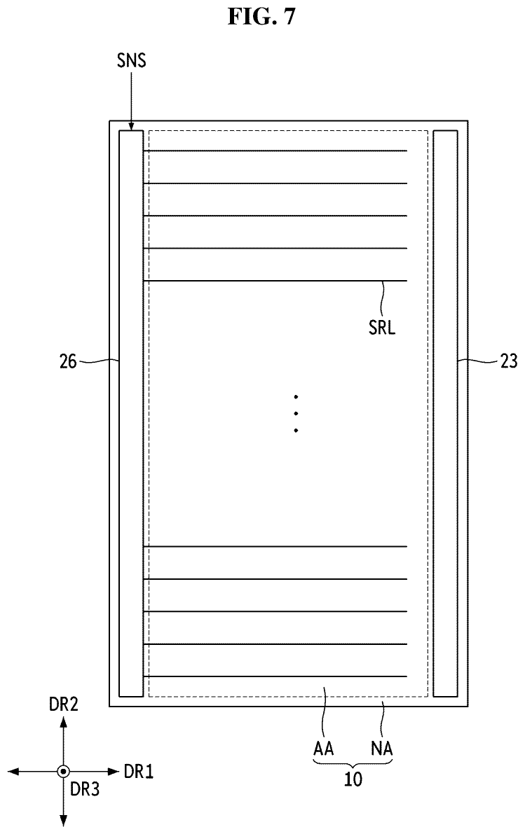

FIG. 7 is a diagram illustrating the placement of the optical sensor driver 26 of the display device 1 according to one embodiment.

The optical sensor driver 26 may be located in the non-display area NA between one edge of the display panel 10 and one edge of the display area AA, which face each other in the first direction DR1. The optical sensor driver 26 may be connected to the scan read lines SRL.

The scan driver 23 may be located in the non-display area NA between the other edge of the display panel 10 and the other edge of the display area AA, which face each other in the first direction DR1.

The display area AA may be located between the optical sensor driver 26 and the scan driver 23.

The optical sensor driver 26 may sequentially output the scan read signals SRS to sequentially supply them to the scan read lines SRL.

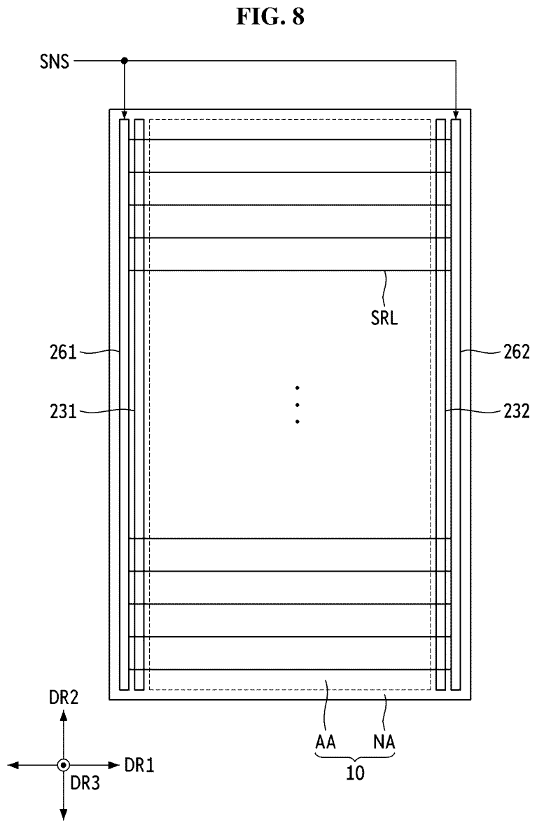

FIG. 8 is a view illustrating the placement of the optical sensor driver 26 of the display device 1 according to one embodiment.

The display device 1 of FIG. 8 differs from the display device 1 of FIG. 6 described above in that it further includes two scan drivers 23. The following description will mainly focus on this difference.

As illustrated in FIG. 8, the scan driver 23 may be provided in plurality. For example, the scan driver 23 may include a first scan driver 231 and a second scan driver 232.

The first scan driver 231 may be located in the non-display area NA between one edge of the display panel 10 and one edge of the display area AA, which face each other in the first direction DR1. For example, the first scan driver 231 may be located in the non-display area NA between one side of the display area AA and the first optical sensor driver 261. The first scan driver 231 may be connected to the scan lines SL. For example, the first scan driver 231 may be connected to one side of the scan lines SL.

The second scan driver 232 may be located in the non-display area NA between the other edge of the display panel 10 and the other edge of the display area AA, which face each other in the first direction DR1. For example, the second scan driver 232 may be located in the non-display area NA between the other side of the display area AA and the second optical sensor driver 262. The second scan driver 232 may be connected to the scan lines SL. For example, the second scan driver 232 may be connected to the other side of the scan lines SL.

The display area AA may be located between the first scan driver 231 and the second scan driver 232.

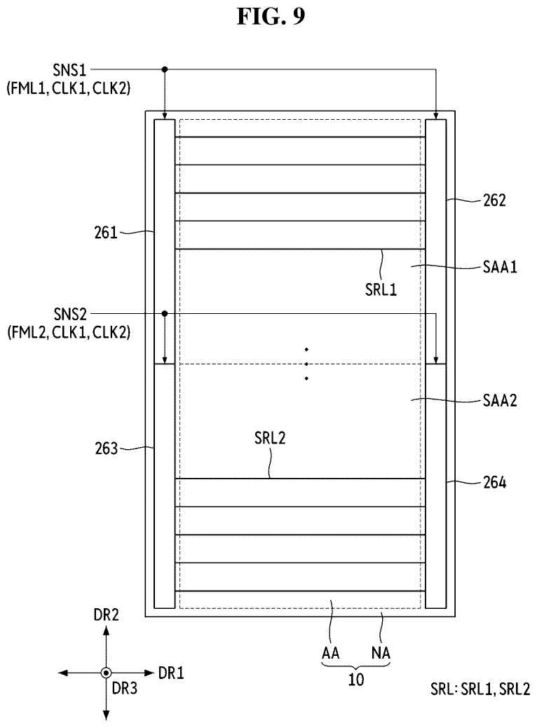

FIG. 9 is a diagram illustrating the placement of the optical sensor driver 26 of the display device 1 according to one embodiment.

As illustrated in FIG. 9, the optical sensor driver 26 may be provided in plurality. For example, the optical sensor driver 26 may include the first optical sensor driver 261, the second optical sensor driver 262, a third optical sensor driver 263, and a fourth optical sensor driver 264.

The display area AA may include a first sub-display area SAA1 and a second sub-display area SAA2. The first sub-display area SAA1 may correspond to an upper side of the display area DA, and the second sub-display area SAA2 may corresponds to a lower side of the display area DA.

The first optical sensor driver 261 and the second optical sensor driver 262 may drive the optical sensors PS arranged in the first sub-display area SAA1, and the third optical sensor driver 263 and the fourth optical sensor driver 264 may drive the optical sensors PS arranged in the second sub-display area SAA2.

The scan read lines SRL, located in the display area AA, may include first scan read lines SRL1 arranged in the first sub-display area SAA1 and second scan read lines SRL2 arranged in the second sub-display area SAA2.

The first optical sensor driver 261 may be disposed in the non-display area NA between one edge of the display panel 10 and one edge of the first sub-display area SAA1, which face each other in the first direction DR1. The first optical sensor driver 261 may be connected to the first scan read lines SRL1. For example, the first optical sensor driver 261 may be connected to one side of the first scan read lines SRL1.

The second optical sensor driver 262 may be disposed in the non-display area NA between the other edge of the display panel 10 and the other edge of the first sub-display area SAA1, which face each other in the first direction DR1. The second optical sensor driver 262 may be connected to the first scan read lines SRL1. For example, the second optical sensor driver 262 may be connected to the other side of the first scan read lines SRL1.

The first sub-display area SAA1 may be located between the first optical sensor driver 261 and the second optical sensor driver 262.

The first optical sensor driver 261 may sequentially output first scan read signals to sequentially supply them to the first scan read lines SRL1.

The second optical sensor driver 262 may sequentially output second scan read signals to sequentially supply them to the second scan read lines SRL2.

The first optical sensor driver 261 and the second optical sensor driver 262 may output the scan read signals SRS having the same output timing. For example, the first scan read signal provided from the first optical sensor driver 261 to one side of the first scan read line SRL1 and the first scan read signal provided from the second optical sensor driver 262 to the other side of the first scan read line SRL1 may have the same output timing. To this end, the first optical sensor driver 261 and the second optical sensor driver 262 may receive the same first sensor control signal SNS1. The first sensor control signal SNS1 may include a first start signal FML1, the first clock signal CLK1, and the second clock signal CLK2.

The third optical sensor driver 263 may be located in the non-display area NA between one edge of the display panel 10 and one edge of the second sub-display area SAA2, which face each other in the first direction DR1. The third optical sensor driver 263 may be connected to the second scan read lines SRL2. For example, the third optical sensor driver 263 may be connected to one side of the second scan read lines SRL2.

The fourth optical sensor driver 264 may be located in the non-display area NA between the other edge of the display panel 10 and the other edge of the second sub-display area SAA2, which face each other in the first direction DR1. The fourth optical sensor driver 264 may be connected to the second scan read lines SRL2. For example, the fourth optical sensor driver 264 may be connected to the other side of the second scan read lines SRL2.

The second sub-display area SAA2 may be located between the third optical sensor driver 263 and the fourth optical sensor driver 264.

The third optical sensor driver 263 may sequentially output second scan read signals to sequentially supply them to the second scan read lines SRL2.

The fourth optical sensor driver 264 may sequentially output second scan read signals to supply them to the second scan read lines SRL2.

The third optical sensor driver 263 and the fourth optical sensor driver 264 may output scan read signals having the same output timing. For example, the second scan read signal provided from the third optical sensor driver 263 to one side of the second scan read line SRL2 and the second scan read signal provided from the fourth optical sensor driver 264 to the other side of the second scan read line SRL2 may have the same output timing. To this end, the third optical sensor driver 263 and the fourth optical sensor driver 264 may receive the same second sensor control signal SNS2. The second sensor control signal SNS2 may include a second start signal FML2, the first clock signal CLK1, and the second clock signal CLK2. Here, the second start signal FML2 of the second sensor control signal SNS2 and the first start signal FML1 of the first sensor control signal SNS1 may have different timings. For example, the second start signal FML2 may be outputted at a later timing than the first start signal FML1. As a result, the second scan read signals may be outputted at a later time than the first scan read signals. However, the present disclosure is not limited thereto, and the first scan read signals and the second scan read signals may be outputted at the same timing.

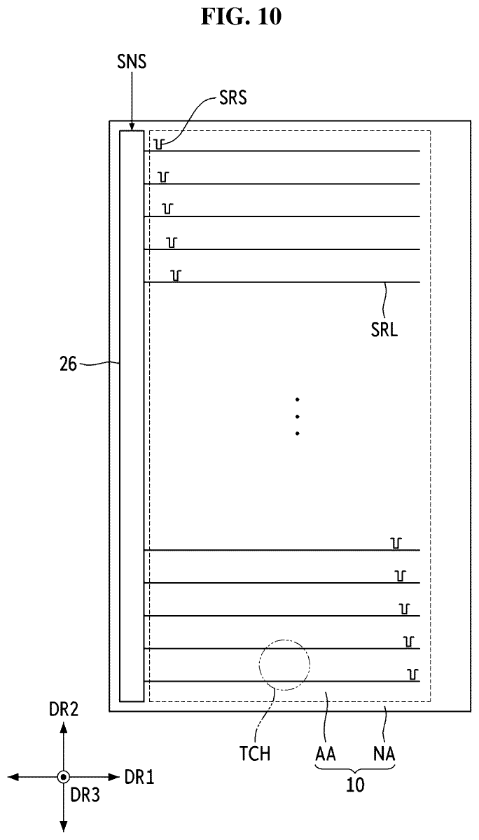

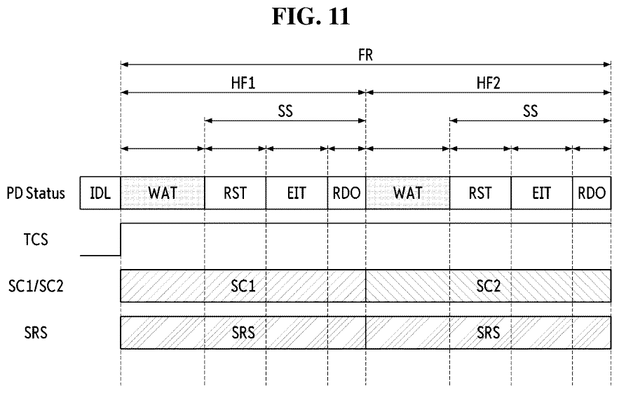

FIGS. 10 and 11 are views illustrating the operation of the display device 1 according to one embodiment when a touch input is located at a lower side of the display area DA.

The display device 1 of FIG. 10 is a display device 1 in which the second optical sensor driver 262 is omitted from the aforementioned display device 1 of FIG. 6. The optical sensor driver 26 of FIG. 10 is the same as the first optical sensor driver 261 of FIG. 9.

A frame period FR may include a first half frame period HF1 and a second half frame period HF2.

The first half frame period HF1 may include a wait period WAT and a sensing period SS.

The sensing period SS of the first half frame period HF1 may include a reset period RST, a light receiving period EIT, and a readout period RDO.

The second half frame period HF2 may include the same periods as the first half frame period HF1. For example, the second half frame period HF2 may include the wait period WAT and the sensing period SS. In this case, the sensing period SS of the second half frame period HF2 may include the reset period RST, the light receiving period EIT, and the readout period RDO.

When a touch TCH is applied to the display panel 10 (e.g., the display area DA of the display panel 10) during an idle period, a touch signal TCS may transition to an active level (e.g., a high level) after the idle period. For example, when the touch TCH is detected on a display area AA of the display panel 10, a touch sensor of the display panel 10 may generate the touch signal TCS according to the touch TCH and provide the generated touch signal TCS to the processor 50. The touch input may be detected by the aforementioned touch sensor layer TSL.

The processor 50 may detect the coordinates (e.g., touch coordinates) of the touch input (e.g., touch TCH) based on the touch signal TCS. For example, the processor 50 may determine the location of the touch input within the display area AA based on the coordinates of the touch input.

When the coordinates of the touch input are detected, the processor 50 may select the optical sensors PS located at positions corresponding to the coordinates of the touch input (or the optical sensors PS located at the respective positions corresponding to the touch input). The respective positions of the optical sensors PS corresponding to the coordinates of the touch input may be determined based on the number of clock signals used to generate the scan read signals SRS associated with the touch input.

Since the optical sensor driver 26 activates the optical sensors PS sequentially on a horizontal line basis in a downward direction from the upper side of the display area DA by sequentially outputting the scan read signals SRS, the readout circuit 40 may read out detection voltages from the plurality of readout lines ROL during the readout period RDO (e.g., a period in which the scan read signals SRS are supplied to the optical sensors PS corresponding to the touch input provided in the display area DA). For example, the processor 50 may control the readout circuit 40 such that the readout operation is performed in accordance with the timing at which the optical sensors PS corresponding to the touch input (e.g., the optical sensors PS of the horizontal line) are activated by the scan read signals SRS. Accordingly, the readout circuit 40 may read out detection voltages from the readout lines ROL while the optical sensors PS corresponding to the touch input are activated. Therefore, the optical sensor driver 26 may enable readout operation of the readout circuit 40 selectively only when the optical sensors PS corresponding to the touch input are activated.

The processor 50 may set the readout period RDO based on the coordinates of the detected touch input (and/or the positions of the optical sensors PS corresponding to the touch input). For example, the position (or timing) of the readout period RDO in the frame period FR may be set based on the coordinates of the touch input. In other words, based on the coordinates of the touch input, the readout operation timing of the readout period RDO in the first half frame period HF1 and the readout operation timing of the readout period RDO in the second half frame period HF2 may be determined.

As illustrated in FIG. 10, when it is determined that the touch input is located at the lower side of the display area AA, the processor 50 may place the readout period RDO of the first half frame period HF1 in the latter half of the first half frame period HF1. In such a case, when the time length of the first half frame period HF1 is sufficiently long, the former half of the first half frame period HF1 may be an empty period. This empty period may be defined as the wait period WAT. Accordingly, by placing the sensing period SS of the first half frame period HF1 in the latter half of the first half frame period HF1, the detection voltages may be read out during the readout period RDO set by the processor.

For example, when it is determined that the touch input is located at the lower side of the display area AA, the timing of the readout period RDO of the first half frame period HF1 may be set such that the readout period RDO is placed in the latter half of the first half frame period HF1. The timing of each of the reset period RST and the light receiving period EIT of the first half frame period HF1 may be set based on the timing of the previously set readout period RDO. For example, the timings of the light receiving period EIT and the reset period RST may be set such that the light receiving period EIT is placed immediately before the readout period RDO, and the reset period RST is placed immediately before the light receiving period EIT.

The respective timings of the wait period WAT, the reset period RST, the light receiving period EIT, and the readout period RDO of the second half frame period HF2 may also be set identically to the respective timings of the wait period WAT, the reset period RST, the light receiving period EIT, and the readout period RDO of the first half frame period HF1 described above.

The operation of the display device 1 during the first half frame period HF1 of the frame period FR is described as follows.

During the first half frame period HF1, the first scan control signal SC1 may be outputted from the scan driver 23, and the scan read signals SRS may be sequentially outputted from the optical sensor driver 26.

The first scan control signal SC1 from the scan driver 23 may be applied to the gate electrodes of the fourth sensor transistors LT4 of the optical sensors PS. Accordingly, all of the fourth sensor transistors LT4 may be turned on. For example, all of the fourth sensor transistors LT4 may be turned on simultaneously during the first half frame period HF1, and may remain turned on during the first half frame period HF1.

The scan read signals SRS from the optical sensor driver 26 may be sequentially applied to the optical sensors PS. The scan read signals SRS may be outputted sequentially from the start point of the first half frame period HF1. To this end, the scan read signal (hereinafter, the first scan read signal) that is outputted first from the optical sensor driver 26 may be outputted from the start point of the first half frame period HF1. Accordingly, the third sensor transistors LT3 may be sequentially turned on during the first half frame period HF1. In this case, when one of the third sensor transistors LT3 is maintained in a turned-on state, all of the other third sensor transistors LT3 may be maintained in a turned-off state.

A scan reset signal GR may be outputted from the scan driver 23 in the reset period RST (e.g., reset period RST of the first half frame period HF1) after the wait period WAT (i.e., dummy period of the first half frame period HF1).

The scan reset signal GR from the scan driver 23 may be applied to the gate electrodes of the second sensor transistors LT2 of the optical sensors PS during the reset period RST. Accordingly, all of the second sensor transistors LT2 may be turned on during the reset period RST. For example, all of the second sensor transistors LT2 may be turned on simultaneously in response to the scan reset signal GR. For example, the second sensor transistors LT2 may remain turned on during the reset period RST. Accordingly, the voltage of the second node N2 of all the optical sensors PS may be reset.

In the light receiving period EIT of the first half frame period HF1, the optical sensors PS corresponding to the touch input may receive light emitted from a plurality of pixels PX. For example, the optical sensors PS may be exposed to light during the light receiving period EIT of the first half frame period HF1. In other words, the first photoelectric conversion element PD1 and the second photoelectric conversion element PD2 may be exposed to light during the light receiving period EIT. In this case, since the fourth sensor transistor LT4 is turned on and the fifth sensor transistor LT5 is turned off in the first half frame period HF1, photoelectric charges generated from the first photoelectric conversion element PD1 may be accumulated at the second node N2 through the fourth sensor transistor LT4.

The readout lines ROL may be read out in the readout period RDO of the first half frame period HF1. For example, in the readout period RDO, the readout circuit 40 may read out the detection voltage of the readout line ROL generated based on the photoelectric charges (e.g., photoelectric charges generated by the first photoelectric conversion element PD1) accumulated at the second node N2 of the optical sensor PS during the light receiving period EIT. In other words, the readout circuit 40 operates to read out the detection voltages of the readout line ROL in the readout period RDO. Here, the detection voltages of the readout line ROL may be, for example, detection voltages (e.g., effective detection voltages) detected from the optical sensors PD associated with the touch input. Based on the detection voltages, it may be determined whether the fingerprint included in the touch input matches or not.

The operation of the display device 1 during the second half frame period HF2 of the frame period FR is described as follows.

The second half frame period HF2 is different from the first half frame period HF1 described above in that the second scan control signal SC2 is outputted instead of the first scan control signal SC1. The difference is mainly described as follows.

In the light receiving period EIT of the second half frame period HF2, the optical sensors PS corresponding to the touch input may receive light provided from the plurality of pixels PX. For example, the optical sensors PS may be exposed to light during the light receiving period EIT of the second half frame period HF2. In other words, the first photoelectric conversion element PD1 and the second photoelectric conversion element PD2 may be exposed to light during the light receiving period EIT. In this case, since the fifth sensor transistor LT5 is turned on and the fourth sensor transistor LT4 is turned off in the second half frame period HF2, photoelectric charges generated from the second photoelectric conversion element PD2 may be accumulated at the second node N2 through the fifth sensor transistor LT5.

The readout lines ROL may be read out in the readout period RDO of the second half frame period HF2. For example, in the readout period RDO, the readout circuit 40 may detect the detection voltage of the readout line ROL generated based on the photoelectric charges (e.g., photoelectric charges generated by the second photoelectric conversion element PD2) accumulated at the second node N2 of the optical sensor PS during the light receiving period EIT. In other words, the readout circuit 40 operates to read the detection voltages of the readout line ROL in the readout period RDO. Here, the detection voltages of the readout line ROL may be, for example, detection voltages (e.g., effective detection voltages) detected from the optical sensors PD associated with the touch input. Based on the detection voltages, it may be determined whether the fingerprint included in the touch input matches or not.

In some embodiments, the optical sensor driver 26 may sequentially drive the scan read lines SRL from the first to the last during the period between the start point of the first half frame period HF1 and the end point of the first half frame period HF1, and may again sequentially drive the scan read lines SRL from the first to the last during the period between the start point of the second half frame period HF2 and the end point of the second half frame period HF2. To this end, the optical sensor driver 26 may sequentially output the scan read signals SRS during the first half frame period HF1 to provide them sequentially from the first scan read line SRL to the last scan read line SRL, and may sequentially output the scan read signals SRS during the second half frame period HF2 to provide them sequentially from the first scan read line SRL to the last scan read line SRL.

In this way, when the touch input is located at the lower side of the display area DA, the optical sensor driver 26 may provide the first scan read signal SRL to the optical sensors PS before the start of the readout period RDO, and may sequentially provide a plurality of scan read signals SRS to the optical sensors PS during the wait period WAT, the reset period RST, the light receiving period EIT, and the readout period RDO.

According to one embodiment, the readout circuit 40 may selectively perform readout operation on the readout lines ROL when the optical sensors PS corresponding to the touch input are activated. Accordingly, the readout circuit 40 may sense the detection voltage faster compared to an exemplary case of reading out all the optical sensors PS including the optical sensors PS that do not correspond to the touch input. In addition, since only the optical sensors PS corresponding to the touch input are selectively read out, the detection voltage may be detected from the optical sensors PS in a short time without a time delay (e.g., time delay corresponding to a difference between the operation time of the pixels PX and the operation time of the optical sensors PS) that may occur when detection voltages of all of the optical sensors PS are read out.

According to one embodiment, when the touch input is located at the lower side of the display area DA, the optical sensor driver 26 may output the scan read signal SRS in advance during a period preceding the readout period RDO (e.g., the reset period RST), so that the scan read signal SRS required in the readout period RDO may be outputted at an earlier time. Accordingly, even when the touch input is located at the lower side of the display area DA corresponding to the lower side of the optical sensor driver 26 rather than the upper side of the display area DA corresponding to the upper side of the optical sensor driver 26, the output timing of the scan read signal SRS used to drive the optical sensors PS corresponding to the touch input located at the lower side may be advanced. Accordingly, even if the touch input is located farther away from the upper side of the optical sensor driver 26, the driving timing of the optical sensors PS corresponding to the touch input may be advanced. Therefore, overall sensing time for sensing the fingerprint may be shortened.

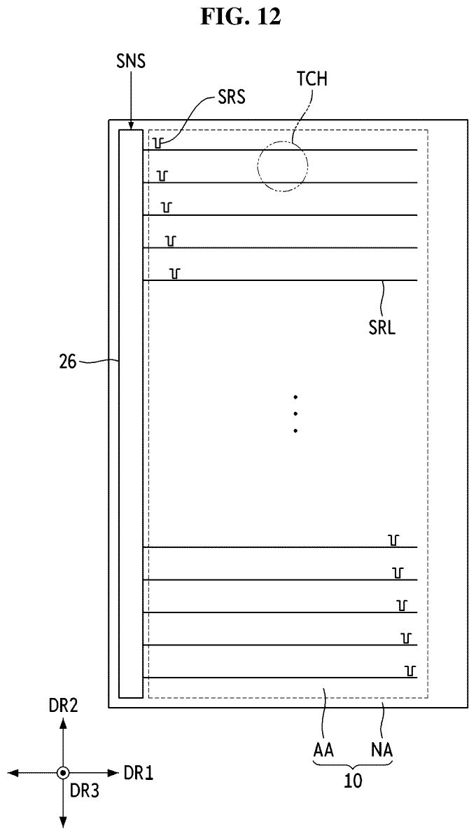

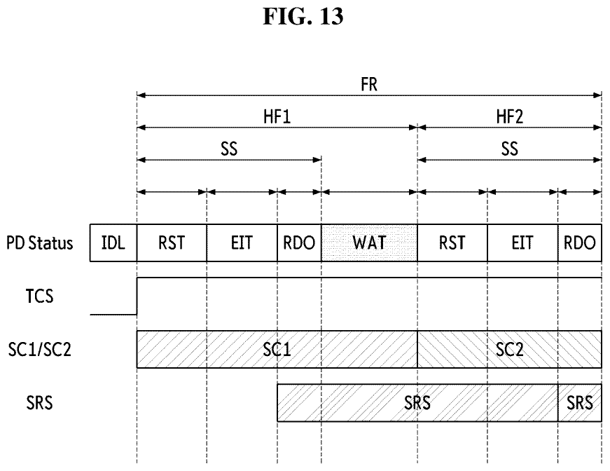

FIGS. 12 and 13 are views illustrating the operation of the display device 1 according to an embodiment when a touch input is located at the upper side of the display area DA.

The display device 1 of FIG. 12 is the same as the display device 1 of FIG. 10 described above.

The frame period FR may include the first half frame period HF1 and the second half frame period HF2.

The first half frame period HF1 may include the sensing period SS and the wait period WAT.

The sensing period SS of the first half frame period HF1 may include the reset period RST, the light receiving period EIT, and the readout period RDO.

The second half frame period HF2 may include the sensing period SS. The sensing period SS of the second half frame period HF2 may be the same as the sensing period SS of the first half frame period HF1 described above. For example, the sensing period SS of the second half frame period HF2 may include the reset period RST, the light receiving period EIT, and the readout period RDO. Since the second half frame period HF2 does not include the wait period WAT, the time length of the second half frame period HF2 may be shorter than the time length of the first half frame period HF1 described above.

The processor 50 may set the readout period RDO based on the coordinates of the detected touch input (e.g., touch TCH) and/or the positions of the optical sensors PS corresponding to the touch input. For example, the position (or timing) of the readout period RDO in the frame period FR may be set based on the coordinates of the touch input. In other words, based on the coordinates of the touch input, the position of the readout period RDO in the first half frame period HF1 and the position of the readout period RDO in the second half frame period HF2 may be determined.

As illustrated in FIG. 12, when it is determined that the touch input is located at the upper side of the display area AA, the processor 50 may place the readout period RDO of the first half frame period HF1 in the former half of the first half frame period HF1. In such a case, when the time length of the first half frame period HF1 is sufficiently great, the latter half of the first half frame period HF1 may be an empty period, and this empty period may be defined as the wait period WAT. In this way, by placing the sensing period SS of the first half frame period HF1 in the former half of the first half frame period HF1, the detection voltages may be read out during the readout period RDO of the first half frame period HF1 set by the processor 50.

In this way, when it is determined that the touch input is located at the upper side of the display area AA, the timing of the readout period RDO of the first half frame period HF1 may be set such that the readout period RDO is placed in the former half of the first half frame period HF1. The timing of each of the reset period RST and the light receiving period EIT of the first half frame period HF1 may be set based on the timing of the previously set readout period RDO. For example, the timings of the light receiving period EIT and the reset period RST may be set such that the light receiving period EIT is placed immediately before the readout period RDO, and the reset period RST is placed immediately before the light receiving period EIT.

The respective timings of the reset period RST, the light receiving period EIT, and the readout period RDO of the second half frame period HF2 may also be set identically to the respective timings of the reset period RST, the light receiving period EIT, and the readout period RDO of the first half frame period HF1 described above. However, since detection voltages detected at the readout lines ROL after the readout period RDO of the second half frame period HF2 are not related to the touch input, the second half frame period HF2 may not include the wait period WAT after the readout period RDO.

The operation of the display device 1 during the first half frame period HF1 of the frame period FR is described as follows.

During the first half frame period HF1, the first scan control signal SC1 may be outputted from the scan driver 23.

The first scan control signal SC1 from the scan driver 23 may be applied to the gate electrodes of the fourth sensor transistors LT4 of the optical sensors PS. Accordingly, all of the fourth sensor transistors LT4 may be turned on. For example, all of the fourth sensor transistors LT4 may be turned on simultaneously during the first half frame period HF1. In other words, the fourth sensor transistors LT4 may remain turned on during the first half frame period HF1.

The scan reset signal GR may be outputted from the scan driver 23 in the reset period RST of the first half frame period HF1.

The scan reset signal GR from the scan driver 23 may be applied to the gate electrodes of the second sensor transistors LT2 of the optical sensors PS. Accordingly, all of the second sensor transistors LT2 may be turned on. For example, during the reset period RST, all of the second sensor transistors LT2 may be turned on simultaneously. In other words, the second sensor transistors LT2 may remain turned on during the reset period RST. Accordingly, the voltage of the second node N2 of all the optical sensors PS may be reset.

In the light receiving period EIT of the first half frame period HF1, the optical sensors PS corresponding to the touch input may receive light provided from the plurality of pixels PX. For example, the optical sensors PS may be exposed to light during the light receiving period EIT of the first half frame period HF1. In other words, the first photoelectric conversion element PD1 and the second photoelectric conversion element PD2 may be exposed to light during the light receiving period EIT. In this case, since the fourth sensor transistor LT4 is turned on and the fifth sensor transistor LT5 is turned off in the first half frame period HF1, photoelectric charges generated from the first photoelectric conversion element PD1 may be accumulated at the second node N2 through the fourth sensor transistor LT4.

The scan read signals SRS may be sequentially output from the optical sensor driver 26 in the readout period RDO of the first half frame period HF1. For example, as illustrated in FIG. 12, when the touch input is located at the upper side of the display area AA, the optical sensor driver 26 provides the scan read signal SRS sequentially from the start point of the first half frame period HF1 (e.g., start point of the reset period RST), the output of the scan read signal SRS may be completed before the readout period RDO. Accordingly, as illustrated in FIG. 13, the scan read signals SRS may be outputted from the start point of the readout period RDO.

The scan read signals SRS from the optical sensor driver 26 may be sequentially applied to the optical sensors PS. The scan read signals SRS may be sequentially output during the period between the start point of the readout period RDO of the first half frame period HF1 and the end point of the light receiving period EIT of the second half frame period HF2. Accordingly, the third sensor transistors LT3 may be sequentially turned on during the period between the start point of the readout period RDO of the first half frame period HF1 and the end point of the light receiving period EIT of the second half frame period HF2. In this case, when one of the third sensor transistors LT3 is maintained in a turned-on state, all of the other third sensor transistors LT3 may be in a turned-off state.

In addition, the readout lines ROL may be read in the readout period RDO of the first half frame period HF1 described above. For example, in the readout period RDO, the readout circuit 40 may detect the detection voltage of the readout line ROL generated based on the photoelectric charges (e.g., photoelectric charges generated by the first photoelectric conversion element PD1) accumulated at the second node N2 of the optical sensor PS during the light receiving period EIT. In other words, the readout circuit 40 operates to read the detection voltages of the readout line ROL in the readout period RDO. Here, the detection voltages of the readout line ROL may be, for example, detection voltages (e.g., effective detection voltages) corresponding to the aforementioned touch input. Based on the detection voltages, it may be determined whether the fingerprint included in the touch input matches or not.

The operation of the display device 1 during the second half frame period HF2 of the frame period FR is described as follows.

The second half frame period HF2 is different from the first half frame period HF1 described above in that the second scan control signal SC2 is outputted instead of the first scan control signal SC1. The difference is mainly described as follows.

In the light receiving period EIT of the second half frame period HF2, the optical sensors PS corresponding to the touch input may receive light provided from the plurality of pixels PX. For example, the optical sensors PS may be exposed to light during the light receiving period EIT of the second half frame period HF2. In other words, the first photoelectric conversion element PD1 and the second photoelectric conversion element PD2 may be exposed to light during the light receiving period EIT. In this case, since the fifth sensor transistor LT5 is turned on and the fourth sensor transistor LT4 is turned off in the second half frame period HF2, photoelectric charges generated from the second photoelectric conversion element PD2 may be accumulated at the second node N2 through the fifth sensor transistor LT5.

During the read out period RDO of the second half frame period HF2, detection voltages may be read out from the read out lines ROL while the scan read lines SRL are being driven. For example, in the readout period RDO, the readout circuit 40 may detect the detection voltage of the readout line ROL generated based on the photoelectric charges (e.g., photoelectric charges generated by the second photoelectric conversion element PD2) accumulated at the second node N2 of the optical sensor PS in the light receiving period EIT. In other words, the readout circuit 40 operates to read the detection voltages of the readout line ROL in the readout period RDO. Here, the detection voltages of the readout line ROL may be, for example, detection voltages (e.g., effective detection voltages) detected from the optical sensors PS associated with the touch input. Based on the detection voltages, it may be determined whether the fingerprint included in the touch input matches or not.

In some embodiments, the optical sensor driver 26 may sequentially drive the scan read lines SRL from the first to the last during a period from the start point of the readout period RDO included in the first half frame period HF1 to the end point of the light receiving period EIT included in the second half frame period HF2, and may again sequentially drive the scan read lines SRL from the first to the last during a period from the start point of the readout period RDO included in the second half frame period HF2 to the end point of the light receiving period EIT included in the next frame period (e.g., first half frame period of the next frame period).

In this way, when the touch input is located at the upper side of the display area DA, the optical sensor driver 26 may output the first scan read signal SRS in the readout period RDO. In this case, the optical sensor driver 26 may sequentially output the plurality of scan read signals SRS during the reset period RST, the light receiving period EIT, and the readout period RDO.

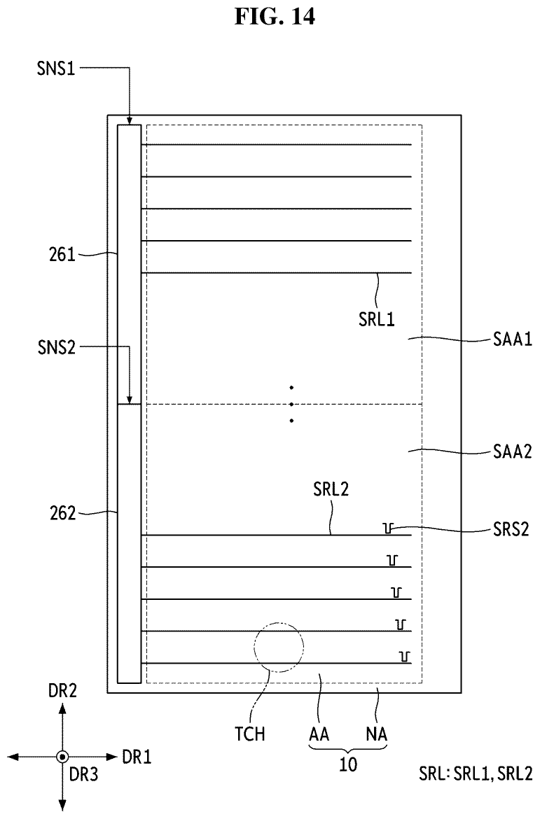

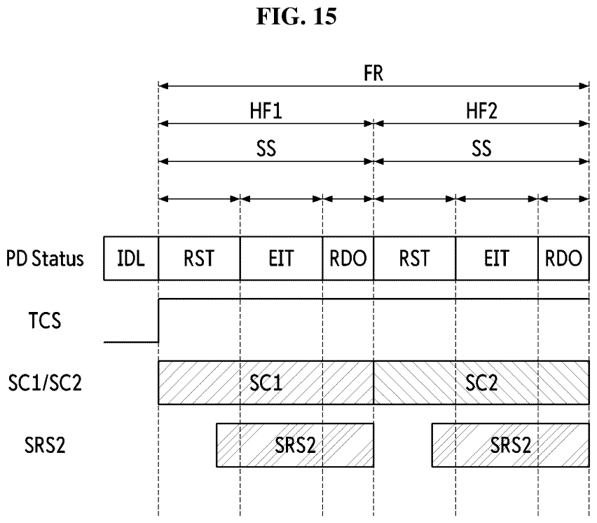

FIGS. 14 and 15 are views illustrating the operation of the display device 1 according to one embodiment when a touch input is located in the second sub-display area SAA2.

The display device 1 of FIG. 14 corresponds to a display device 1 from which the second optical sensor driver 262 and the fourth optical sensor driver 264 of the display device 1 of FIG. 9 described above are omitted. The first optical sensor driver 261 of FIG. 14 corresponds to the first optical sensor driver 261 of FIG. 9, and the second optical sensor driver 262 of FIG. 14 corresponds to the third optical sensor driver 263 of FIG. 9.

A frame period FR may include a first half frame period HF1 and a second half frame period HF2.

The first half frame period HF1 may include the sensing period SS.

The sensing period SS of the first half frame period HF1 may include a reset period RST, a light receiving period EIT, and a readout period RDO.

The second half frame period HF2 may include the same operation periods as the first half frame period HF1. For example, the second half frame period HF2 may include the sensing period SS, which may include the reset period RST, the light receiving period EIT, and the readout period RDO.

As illustrated in FIG. 14, when it is determined that a touch input (e.g., touch TCH) is located in the second sub-display area SAA2 (e.g., the lower side of the display area AA), the processor 50 may select the second optical sensor driver 262, which drives the second scan read lines SRL2 of the second sub-display area SAA2, from among the first optical sensor driver 261 and the second optical sensor driver 262. For example, when it is determined that the touch input is located in the second sub-display area SAA2 (e.g., the lower side of the display area AA), the processor 50 may drive the second optical sensor driver 262, and may not drive the first optical sensor driver 261.

As illustrated in FIG. 14, when it is determined that the touch input is located in the second sub-display area SAA2 (e.g., the lower side of the display area AA), the processor 50 may control the second optical sensor driver 262 to output the lower scan read signals SRS2 sequentially during a period between the midpoint of the reset period RST included in the first half frame period HF1 and the end point of the readout period RDO included in the first half frame period HF1. For example, the lower scan read signals SRS2 may be sequentially outputted during the period between the midpoint of the reset period RST included in the first half frame period HF1 and the end point of the readout period RDO included in the first half frame period HF1. In the same manner, the lower scan read signals SRS2 may be sequentially outputted during a period between the midpoint of the reset period RST included in the second half frame period HF2 and the end point of the readout period RDO included in the second half frame period HF2.

Furthermore, since the second optical sensor driver 262 drives only the second scan read lines SRL2 of the second sub-display area SAA2 having a smaller area than the display area AA, the time length of the first half frame period HF1 may be shorter than the time length of the first half frame period HF1 of FIG. 11 described above. Therefore, the first half frame period HF1 of FIG. 15 may not include the wait period WAT.

The respective timings of the reset period RST, the light receiving period EIT, and the readout period RDO of the second half frame period HF2 may be set identically to the respective timings of the reset period RST, the light receiving period EIT, and the readout period RDO of the first half frame period HF1 described above.

Furthermore, since the first optical sensor driver 261 drives only the first scan read lines SRL1 of the first sub-display area SAA1 having an area smaller than the display area AA, the time length of the second half frame period HF2 may be less than the time length of the second half frame period HF2 of FIG. 11 described above. Therefore, the second half frame period HF2 of FIG. 15 may not include the wait period WAT.

The operation of the display device 1 during the first half frame period HF1 of the frame period FR is described as follows.

During the first half frame period HF1, the first scan control signal SC1 may be output from the scan driver 23.

The first scan control signal SC1 from the scan driver 23 may be applied to the gate electrodes of the fourth sensor transistors LT4 of the optical sensors PS. Accordingly, all of the fourth sensor transistors LT4 may be turned on. For example, all of the fourth sensor transistors LT4 may be turned on simultaneously during the first half frame period HF1. In other words, the fourth sensor transistors LT4 may remain turned on during the first half frame period HF1.

The scan reset signal GR may be outputted from the scan driver 23 in the reset period RST of the first half frame period HF1.

The scan reset signal GR from the scan driver 23 may be applied to the gate electrodes of the second sensor transistors LT2 of the optical sensors PS. Accordingly, all of the second sensor transistors LT2 may be turned on. For example, during the reset period RST, all of the second sensor transistors LT2 may be turned on simultaneously. In other words, the second sensor transistors LT2 may remain turned on during the reset period RST. Accordingly, the voltage of the second node N2 of all the optical sensors PS may be reset.

At around midpoint of the reset period RST of the first half frame period HF1, upper scan read signals SRS1 may be sequentially output from the first optical sensor driver 261.

The upper scan read signals SRS1 from the first optical sensor driver 261 may be sequentially applied to the optical sensors PS. The upper scan read signals SRS1 may be sequentially outputted during the period between the midpoint of the reset period RST included in the first half frame period HF1 and the end point of the readout period RDO included in the first half frame period HF1. Accordingly, the third sensor transistors LT3 may be sequentially turned on during the period between the midpoint of the reset period RST included in the first half frame period HF1 and the end point of the readout period RDO included in the first half frame period HF1. In this case, when one of the third sensor transistors LT3 is maintained in a turned-on state, all of the other third sensor transistors LT3 may be in a turned-off state.

In the light receiving period EIT of the first half frame period HF1, the optical sensors PS corresponding to the touch input may receive light provided from a plurality of pixels PX. For example, the optical sensors PS may be exposed to light during the light receiving period EIT of the first half frame period HF1. In other words, the first photoelectric conversion element PD1 and the second photoelectric conversion element PD2 may be exposed to light during the light receiving period EIT. In this case, since the fourth sensor transistor LT4 is turned on and the fifth sensor transistor LT5 is turned off in the first half frame period HF1, photoelectric charges generated from the first photoelectric conversion element PD1 may be accumulated at the second node N2 through the fourth sensor transistor LT4.

The readout lines ROL may be read out in the readout period RDO of the first half frame period HF1. For example, in the readout period RDO, the readout circuit 40 may read out the detection voltage of the readout line ROL generated based on the photoelectric charges (e.g., photoelectric charges generated by the first photoelectric conversion element PD1) accumulated at the second node N2 of the optical sensor PS during the light receiving period EIT. In other words, the readout circuit 40 operates to read the detection voltages of the readout line ROL in the readout period RDO. Here, the detection voltages of the readout line ROL may be, for example, detection voltages (e.g., effective detection voltages) detected from the optical sensor PS associated with the touch input. Based on the detection voltages, it may be determined whether the fingerprint included in the touch input matches or not.

The operation of the display device 1 during the second half frame period HF2 of the frame period FR is described as follows.

The second half frame period HF2 is different from the first half frame period HF1 described above in that the second scan control signal SC2 is output instead of the first scan control signal SC1. The difference is mainly described as follows.

During the second half frame period HF2, the second scan control signal SC2 may be outputted from the scan driver 23.

The second scan control signal SC2 from the scan driver 23 may be applied to the gate electrodes of the fifth sensor transistors LT5 of the optical sensors PS. Accordingly, all of the fifth sensor transistors LT5 may be turned on. For example, during the second half frame period HF2, all of the fifth sensor transistors LT5 may be turned on simultaneously. In other words, the fifth sensor transistors LT5 may remain turned on during the second half frame period HF2.

During the light receiving period EIT of the second half frame period HF2, the optical sensors PS corresponding to the touch input may receive light provided from the plurality of pixels PX. For example, the optical sensors PS may be exposed to light during the light receiving period EIT of the second half frame period HF2. In other words, the first photoelectric conversion element PD1 and the second photoelectric conversion element PD2 may be exposed to light during the light receiving period EIT. In this case, since the fourth sensor transistor LT4 is turned off and the fifth sensor transistor LT5 is turned on in the second half frame period HF2, photoelectric charges generated from the second photoelectric conversion element PD2 may be accumulated at the second node N2 through the fifth sensor transistor LT5.

The readout lines ROL may be read in the readout period RDO of the second half frame period HF2. For example, in the readout period RDO, the readout circuit 40 may detect the detection voltage of the readout line ROL generated based on the photoelectric charges (e.g., photoelectric charges generated by the second photoelectric conversion element PD2) accumulated at the second node N2 of the optical sensor PS during the light receiving period EIT. In other words, the readout circuit 40 operates to read the detection voltages of the readout line ROL in the readout period RDO. Here, the detection voltages of the readout line ROL may be, for example, detection voltages (e.g., effective detection voltages) detected from the optical sensor PS associated with the touch input. Based on the detection voltages, it may be determined whether the fingerprint included in the touch input matches or not.

In this way, when the touch input is located in the second sub-display area SAA2, the second optical sensor driver 262 may output a first one of the lower scan read signals SRS2 before the start of the readout period RDO. For example, the second optical sensor driver 262 may output a first one of the lower scan read signals SRS2 in the reset period RST. In this case, the second optical sensor driver 262 may sequentially output a plurality of lower scan read signals SRS2 during the reset period RST, the light receiving period EIT, and the readout period RDO.

According to one embodiment, since the optical sensors PS of the display area DA are activated separately by the first optical sensor driver 261 and the second optical sensor driver 262, fingerprint sensing may be performed more quickly without the wait period WTA.

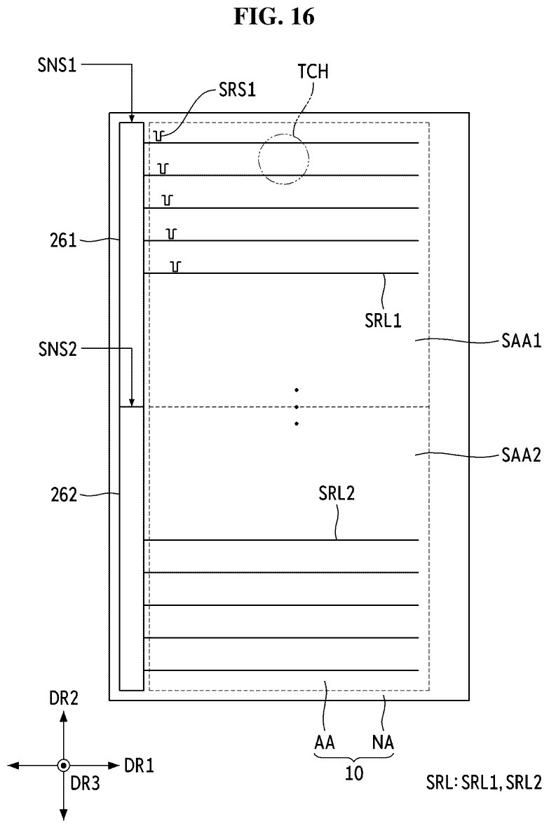

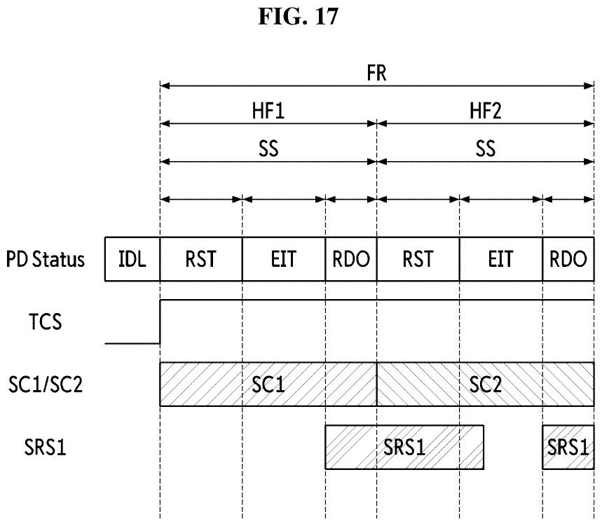

FIGS. 16 and 17 are views illustrating the operation of the display device 1 according to one embodiment when a touch input is located in the first sub-display area SAA1.

The display device 1 of FIG. 16 may be the same as the display device 1 of FIG. 14 described above.

The operation of the display device 1 according to FIGS. 16 and 17 is different from the operation of the display device 1 according to FIGS. 14 and 15 described above in the timing of the upper scan read signals SRS1. The difference is mainly described as follows.

As illustrated in FIG. 16, when it is determined that a touch input (e.g., touch TCH) is located in the first sub-display area SAA1 (e.g., the upper side of the display area AA), the processor 50 may select the first optical sensor driver 261, which drives the first scan read lines SRL1 of the first sub-display area SAA1, from among the first optical sensor driver 261 and the second optical sensor driver 262. For example, when it is determined that the touch input is located in the first sub-display area SAA1 (e.g., the upper side of the display area AA), the processor 50 may drive the first optical sensor driver 261, and may not drive the second optical sensor driver 262.

As illustrated in FIG. 16, when it is determined that the touch input is located in the first sub-display area SAA1 (e.g., the upper side of the display area AA), the processor 50 may control the first optical sensor driver 261 to output the upper scan read signals SRS1 sequentially from the readout period RDO included in the first half frame period HF1. For example, the upper scan read signals SRS1 may be sequentially output from the start point of the readout period RDO included in the first half frame period HF1 to the midpoint of the light receiving period EIT included in the second half frame period HF2. In the same manner, the upper scan read signals SRS1 may be sequentially output from the start point of the readout period RDO included in the second half frame period HF2 to the midpoint of the light receiving period EIT included in the next frame period FR (e.g., the first half frame period HF1 of the next frame period FR).

In this way, when the touch input is located in the first sub-display area SAA1, the first optical sensor driver 261 may output a first one of the upper scan read signals SRS1 in the readout period RDO. In this case, the first optical sensor driver 261 may sequentially output a plurality of upper scan read signals SRS1 during the reset period RST, the reset period RST of the next period (e.g., the second half frame period HF2), and the light receiving period EIT of the next period (e.g., the second half frame period HF2).

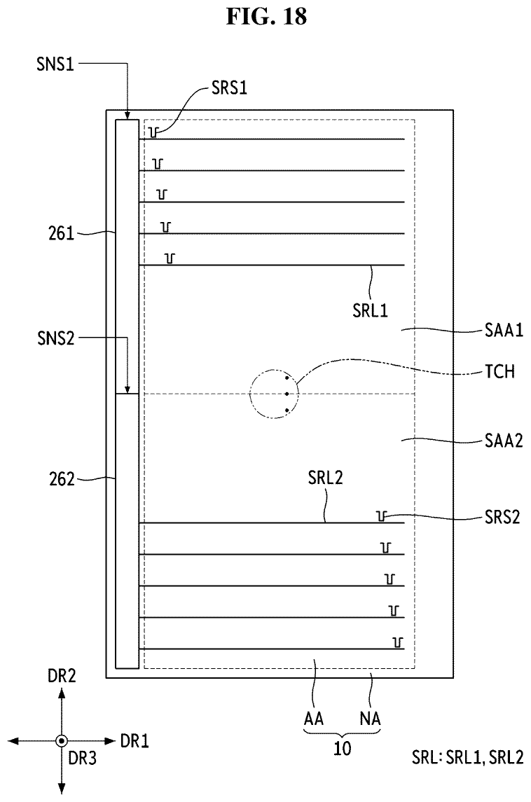

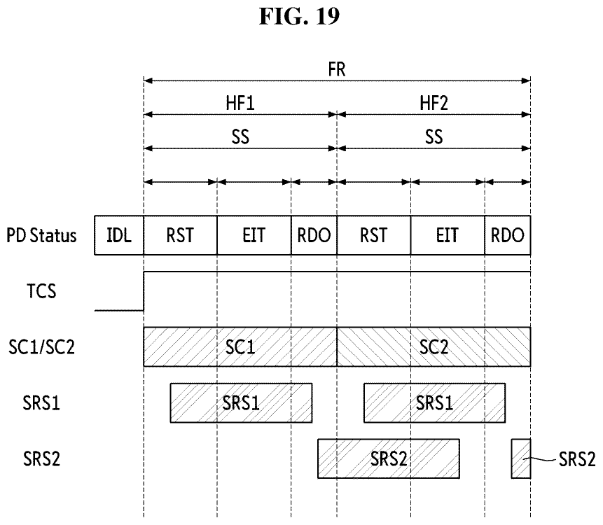

FIG. 18 and FIG. 19 are views illustrating the operation of the display device 1 according to one embodiment when a touch input is located in an area overlapping the interface between the first sub-display area SAA1 and the second sub-display area SAA2.

The display device 1 of FIG. 18 is the same as the display device 1 of FIG. 14 described above.

The operation of the display device 1 of FIGS. 18 and 19 is different from the operation of the display device 1 of FIGS. 14 to 17 described above in the timings of the upper scan read signals SRS1 and the lower scan read signals SRS2. The difference is mainly described as follows.

As illustrated in FIG. 18, when it is determined that a touch input (e.g., touch TCH) is located in an area overlapping the interface between the first sub-display area SAA1 and the second sub-display area SAA2 (e.g., the center of the display area AA), the processor 50 may select both the first optical sensor driver 261 and the second optical sensor driver 262. For example, when it is determined that the touch input is located in the area overlapping the interface between the first sub-display area SAA1 and the second sub-display area SAA2 (e.g., the center of the display area AA), the processor 50 may drive both the first optical sensor driver 261 and the second optical sensor driver 262.

As illustrated in FIG. 18, when it is determined that the touch input is located in the area overlapping the interface between the first sub-display area SAA1 and the second sub-display area SAA2, the processor 50 may control the first optical sensor driver 261 to output the upper scan read signals SRS1 from the midpoint of the reset period RST. For example, the upper scan read signals SRS1 may be sequentially outputted from the midpoint of the reset period RST included in the first half frame period HF1 to the midpoint of the readout period RDO included in the first half frame period HF1. In the same manner, the upper scan read signals SRS1 may be sequentially outputted from the midpoint of the reset period RST included in the second half frame period HF2 to the midpoint of the readout period RDO included in the second half frame period HF2.

As illustrated in FIG. 18, when it is determined that the touch input is located in the area overlapping the interface between the first sub-display area SAA1 and the second sub-display area SAA2 (e.g., the center of the display area AA), the processor 50 may control the second optical sensor driver 262 to output the lower scan read signals SRS2 from the readout period RDO of the first half frame period HF1. For example, the lower scan read signals SRS2 may be sequentially outputted from the midpoint of the readout period RDO included in the first half frame period HF1 to the midpoint of the light receiving period EIT included in the second half frame period HF2. In the same manner, the lower scan read signals SRS2 may be sequentially outputted from the midpoint of the readout period RDO included in the second half frame period HF2 to the midpoint of the light receiving period EIT included in the next frame period FR (e.g., the first half frame period HF1 of the next frame period FR).

According to the operation of the display device 1 of FIGS. 18 and 19, detection voltages (e.g., detection voltages generated by the first photoelectric conversion elements PD1) corresponding to the touch input of the first sub-display area SAA1 may be detected during the former half of the readout period RDO of the first half frame period HF1, and detection voltages (e.g., detection voltages generated by the first photoelectric conversion elements PD1) corresponding to the touch input of the second sub-display area SAA2 may be detected during the latter half of the readout period RDO of the first half frame period HF1. Similarly, detection voltages (e.g., detection voltages generated by the second photoelectric conversion elements PD2) for the touch input of the first sub-display area SAA1 may be detected during the former half of the readout period RDO of the second half frame period HF2, and detection voltages (e.g., detection voltages generated by the second photoelectric conversion elements PD2) for the touch input of the second sub-display area SAA2 may be detected during the latter half of the readout period RDO of the second half frame period HF2.

In this way, when the touch input is located in an area overlapping the interface between the first sub-display area SAA1 and the second sub-display area SAA2, the first optical sensor driver 261 may output a first one of the upper scan read signals SRS1 before the midpoint of the readout period RDO, and the second optical sensor driver 262 may output a first one of the lower scan read signals SRS2 after the midpoint of the readout period RDO. For example, the first optical sensor driver 261 may sequentially output the plurality of upper scan read signals SRS1 during the reset period RST, the light receiving period EIT, and the former half of the readout period RDO. In addition, the second optical sensor driver 262 may sequentially output a plurality of lower scan read signals SRS2 during the latter half of the readout period RDO, the reset period RST of the next period (e.g., the second half frame period HF2), and the light receiving period EIT of the next period (e.g., the second half frame period HF2).

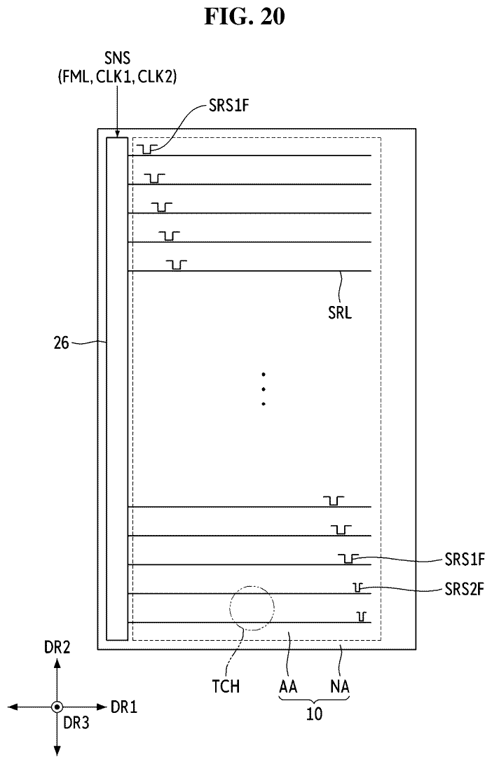

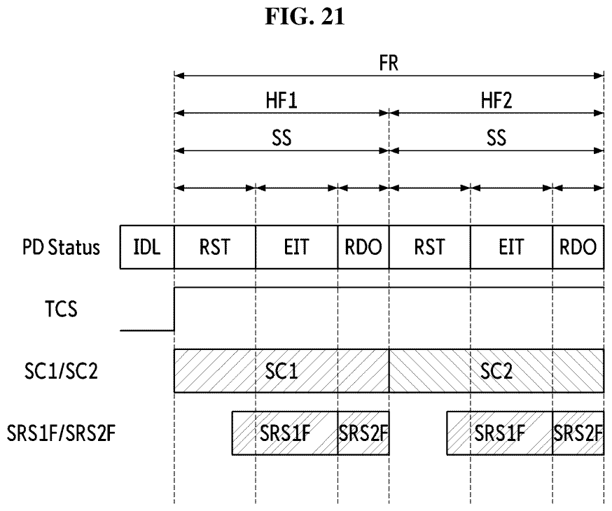

FIG. 20 and FIG. 21 are views illustrating the operation of the display device 1 according to one embodiment when a touch input is located at the lower side of the display area DA.

The display device 1 of FIG. 20 is different from the display device 1 of FIG. 10 described above in that the optical sensor driver 26 may output the scan read signals SRS1 and SRS2 having different frequencies. For example, the optical sensor driver 26 of the display device 1 of FIG. 18 may output the first-frequency scan read signal SRS1F and the second-frequency scan read signal SRS2F, in which the second scan read signal SRS2F has a different frequency from that of the first scan read signal SRS1, and sequentially provide them to the scan read lines SRL. The frequency of the first-frequency scan read signal SRS1F may be higher than the frequency of the second scan read signal SRS2F. In this case, a driving time (hereinafter, first driving time) of a plurality of scan read lines SRL, sequentially supplied with the first-frequency scan read signals SRS1F may be shorter than a driving time (hereinafter, second driving time) of a plurality of scan read lines SRL sequentially supplied with the second-frequency scan read signals SRS2F. For example, the first driving time may be shorter than the second driving time.

The first-frequency scan read signal SRS1F may be outputted in a period other than the readout period RDO, and the second-frequency scan read signal SRS2F may be outputted in the readout period RDO.

The frequency of the scan read signal may be changed, for example, by changing the frequencies of the clock signals CLK1 and CLK2 used to generate the scan read signals.

The operation of the display device 1 of FIGS. 20 and 21 is described in detail as follows.

When the touch TCH is detected on the display panel 10 during an idle period, the touch signal TCS may transition to an active level (e.g., a high level) after the idle period. For example, when a touch input is detected on the display area AA of the display panel 10, a touch sensor of the display panel 10 may generate the touch signal TCS corresponding to the touch input and provide the generated touch signal TCS to the processor 50.

The processor 50 may detect the coordinates (e.g., touch coordinates) of the touch input (e.g., touch TCH) based on the touch signal TCS. For example, the processor 50 may detect where the touch input is located in the display area AA based on the touch coordinates of the touch input.

When the coordinates of the touch input are determined, the processor 50 may select the optical sensors PS corresponding to the touch input based on the respective positions of the optical sensors PS with respect to the touch input. The positions of the optical sensors PS corresponding to the touch input may be determined based on the number of clock signals used to generate the aforementioned scan read signals SRS.

Since the optical sensors PS may be sequentially activated on a horizontal line basis by the sequentially outputted scan read signals SRS1 and SRS2, the processor 50 may control the readout circuit 40 to perform a readout operation in synchronization with the timing of the scan read signals SRS applied to the optical sensors PS corresponding to the touch input (e.g., optical sensors PS of the horizontal line). Accordingly, the readout circuit 40 may read out detection voltages from the readout lines ROL when the optical sensors PS corresponding to the touch input are activated. Therefore, the readout circuit 40 may selectively operate when the optical sensors PS corresponding to the touch input are activated.

The processor 50 may set the readout period RDO based on the coordinates of the detected touch input (and/or the positions of the optical sensors PS corresponding to the touch input).

The optical sensor driver 26 may output a scan read signal having a higher frequency in the remaining period other than the readout period RDO than the frequency of a scan read signal in the readout period RDO. For example, the optical sensor driver 26 may output the second scan read signal SRS2 having a normal frequency in the readout period RDO, and output the first scan read signal SRS1 having a higher frequency in the remaining period other than the readout period RDO. For example, as illustrated in FIG. 21, the first scan read signals SRS1 may be sequentially outputted during the reset period RST and the light receiving period EIT, and the lower scan read signals SRS2 may be sequentially outputted during the readout period RDO. Accordingly, even if the touch input is located at the lower side of the display area AA, which is distant from the first scan read line SRL, the readout operation may be performed at a high speed.

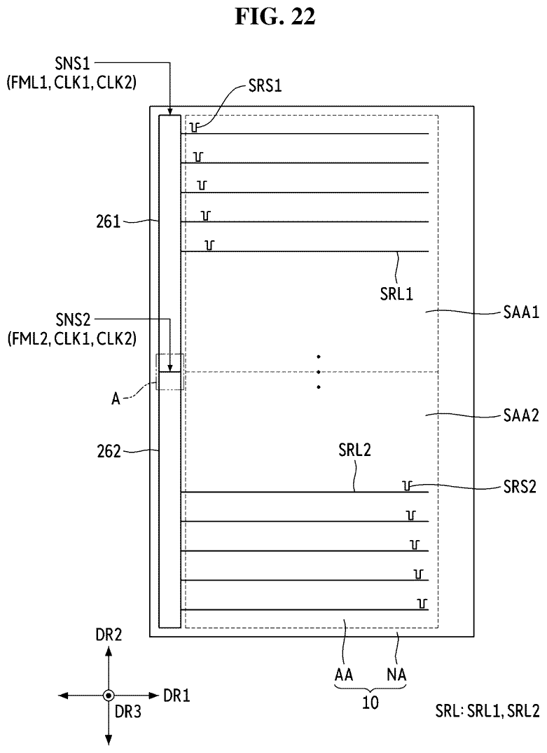

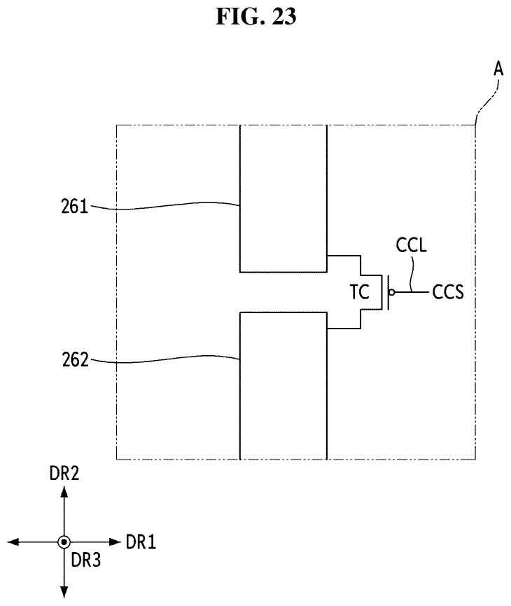

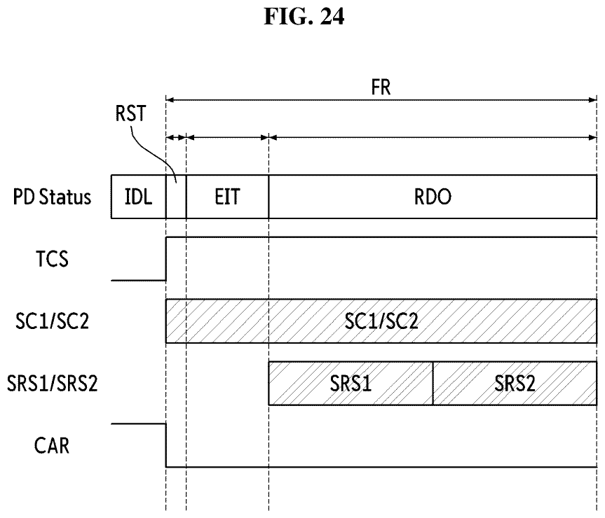

FIG. 22 shows the display device 1 according to one embodiment. FIG. 23 is an enlarged view of area A of FIG. 22. FIG. 24 illustrates the output of the scan read signal SRS in accordance with a carry control signal CCS of FIG. 23.

The display device 1 of FIG. 22 is different from the display device 1 of FIG. 14 described above in that it further includes a carry transistor TC. The difference is mainly described as follows.

The first optical sensor driver 261 may output the first scan read signals SRS1 and sequentially supply them to the first scan read lines SRL1.

The second optical sensor driver 262 may output the lower scan read signals SRS2 and sequentially supply them to second scan read lines SRL2.

The first optical sensor driver 261 may be connected to the second optical sensor driver 262 by the carry transistor TC.

The carry transistor TC may provide a last one of the upper scan read signals SRS1 from the first optical sensor driver 261 to the second optical sensor driver 262 as a carry signal. In this case, the second optical sensor driver 262 may be enabled in response to a last one of the upper scan read signals SRS1 from the first optical sensor driver 261. The enabled second optical sensor driver 262 may sequentially output the lower scan read signals SRS2.

By using the carry transistor TC, the second optical sensor driver 262 may sequentially output the lower scan read signals SRS2 immediately after the first optical sensor driver 261 outputs the upper scan read signals SRS1.

The gate electrode of the carry transistor TC may be connected to a carry control line CCL, the first electrode of the carry transistor TC may be connected to a scan output terminal (e.g., the last scan output terminal) of the first optical sensor driver 261, and the second electrode of the carry transistor TC may be connected to a carry input terminal of the second optical sensor driver 262. One of the first electrode and the second electrode of the carry transistor TC may be a source electrode, and the other may be a drain electrode.

The carry transistor TC may be turned on by the carry control signal CCS from the carry control line CCL. The scan output terminal (e.g., the last scan output terminal) of the first optical sensor driver 261 may be connected to the carry input terminal of the second optical sensor driver 262 by turning on the carry transistor TC.

When the carry transistor TC is turned on, the first optical sensor driver 261 may be connected to the second optical sensor driver 262. In this case, the second start signal FML2 needs not be applied to the second optical sensor driver 262. For example, the last one of the upper scan read signals SRS1 from the first optical sensor driver 261 may replace the role of the second start signal FML2 described above.

When the carry transistor TC is turned off, the first optical sensor driver 261 may be separated from the second optical sensor driver 262. In this case, the second start signal FML2 may be applied to the second optical sensor driver 262.

The aforementioned carry control signal CCS may be generated by the timing controller 21. For example, the carry control signal CCS from the timing controller 21 may be provided to the carry transistor TC through the carry control line CCL.

As illustrated in FIG. 24, the carry control signal CCS may have an active level (e.g., a low level) during the frame period FR. In this case, the upper scan read signals SRS1 and the lower scan read signals SRS2 may be sequentially outputted during the readout period RDO. For example, the upper scan read signals SRS1 may be sequentially output during the former half of the readout period RDO, and the lower scan read signals SRS2 may be sequentially output during the latter half of the readout period RDO.

The display device 1 according to the embodiment may be applied to various electronic devices. An electronic device according to one embodiment may include the above-described display device 1, and may further include, in addition to the display device 1, a module or device having other additional functions.

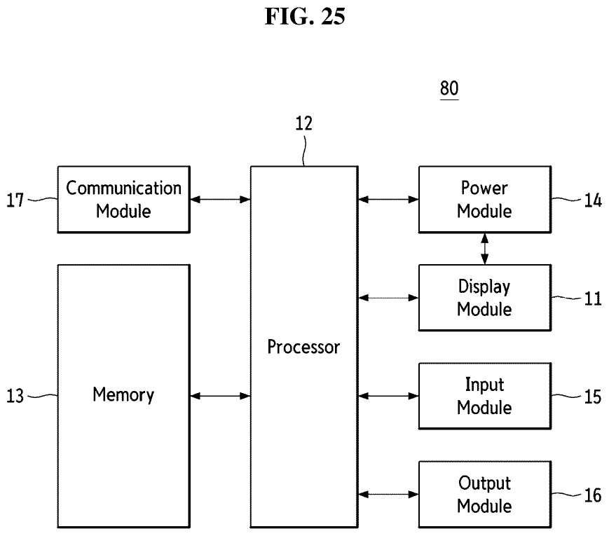

FIG. 25 is a block diagram of an electronic device according to one embodiment. Referring to FIG. 25, an electronic device 80 according to one embodiment may include a display module 11, a processor 12, a memory 13, and a power module 14. The electronic device 80 may further include an input module 15, an output module (e.g., a non-image output module) 16 and/or a communication module 17.

The electronic device 80 may output various types of information as images through the display module 11. When the processor 12 executes an application stored in the memory 13, image information provided by the application may be provided to a user through the display module 11. The power module 14 may include a power supply module, such as a power adapter or a battery device, and a power conversion module that converts power supplied by the power supply module to generate power required for the operation of the electronic device 80. The input module 15 may provide input information to the processor 12 and/or the display module 11. The non-image output module 16 may serve to receive information other than images, such as sound, haptics, luminescence, etc., sent from the processor 12, and provide it to the user. The communication module 17 is a module responsible for the transmission and reception of information between the electronic device 80 and an external device, and may include a receiver and a transmitter.

At least one of the components of the electronic device 80 described above may be included in the display device according to the embodiments described above. Further, some of individual modules functionally included in one module may be included in the display device and some others may be provided separately from the display device. For example, the display device may include the display module 11, and the processor 12, the memory 13, and the power module 14 may be provided in the form of other devices in the electronic device 50 other than the display device.

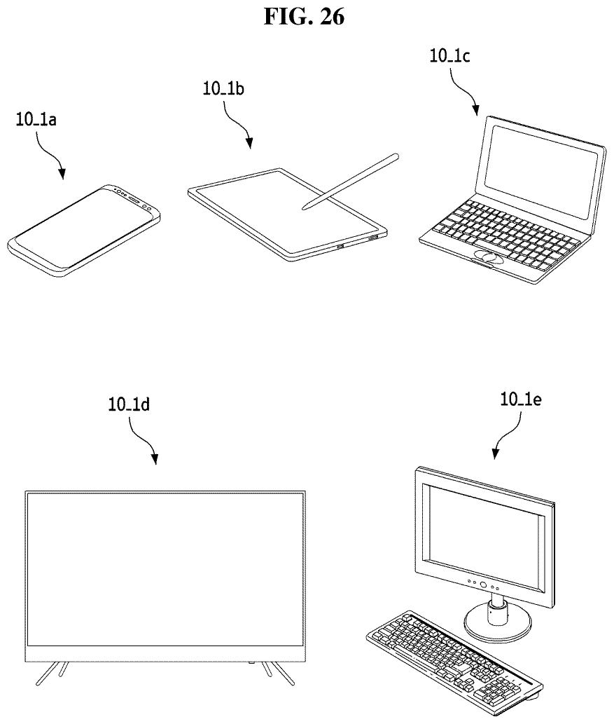

FIGS. 26, 27 and 28 are schematic views illustrating electronic devices according to various embodiments. FIGS. 26 to 28 illustrate examples of various electronic devices to which the display device 1 according to embodiments are applied.

FIG. 26 shows a smartphone 10_1a, a tablet PC 10_1b, a laptop 10_1c, a TV 10_1d, and a desk monitor 10_1e as examples of electronic devices.

The smartphone 10_1a may include a communication module and an input module such as a touch sensor in addition to the display module 11. The smartphone 10_1a may process the information received through the communication module or input module and display the processed information through the display module of the display device.

Each of the tablet PC 10_1b, the laptop 10_1c, the TV 10_1d, and the desktop monitor 10_1e may include a display module and an input module, similarly to the smartphone 10_1a, and may further include a communication module in some cases.

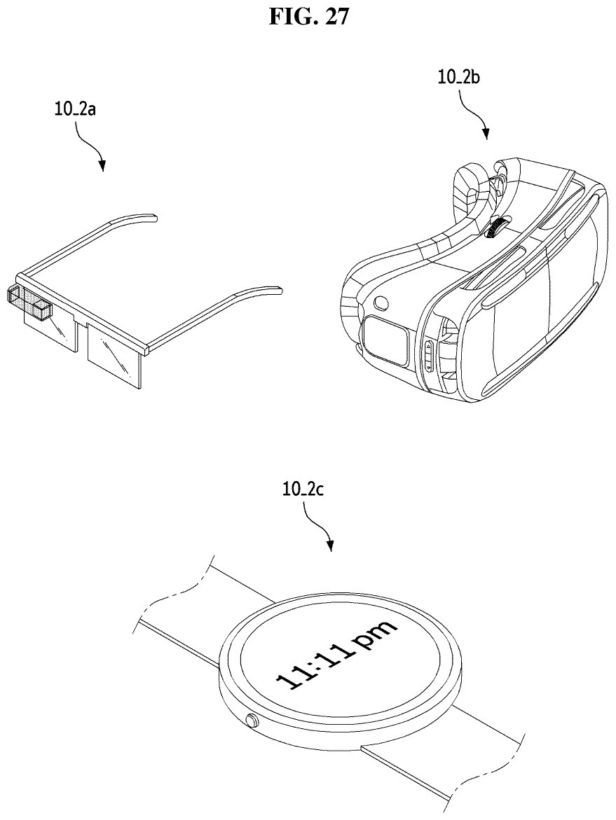

FIG. 27 illustrates a case in which an electronic device including a display module is applied to a wearable electronic device. The wearable electronic device may be smart glasses 10_2a, a head mounted display 10_2b, a smart watch 10_2c, and the like.

The smart glasses 10_2a and the head mounted display 10_2b may include a display module that outputs a display image and a reflector that reflects the outputted display image to provide it to the user's eyes, thereby providing the user with a virtual reality or augmented reality screen.

The smart watch 10_2c may include a biometric sensor as an input device, and may provide biometric information recognized through the biometric sensor to the user through a display module.

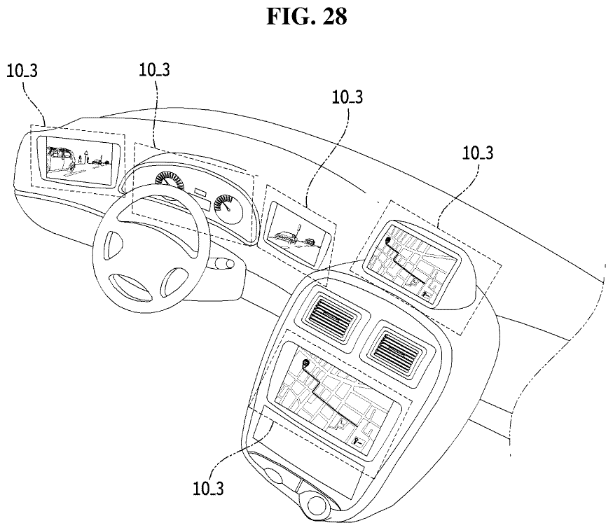

FIG. 28 illustrates a case in which an electronic device including a display module is applied to a vehicle. For example, an electronic device 10_3 may be applied to a vehicle's instrument panel or center fascia, or may be applied to a center information display (CID) placed on the vehicle's dashboard or a room mirror display that replaces a side mirror.

Hitherto, several embodiments of the present disclosure have been described above, but these are merely exemplary and are not intended to limit the present disclosure. Those skilled in the art will appreciate that many variations and modifications can be made to described embodiments without substantially departing from the principles of the present disclosure.

What is claimed is:

1. A display device comprising:
a display panel comprising a display area and a non-display area;
a plurality of pixels and a plurality of optical sensors disposed in the display area, each of the plurality of pixels including a light emitting element and each of the plurality of optical sensors including a photoelectric conversion element;
a scan driver configured to provide a plurality of scan signals to the plurality of pixels and the plurality of optical sensors through a plurality of scan lines;
a readout circuit connected to the plurality of optical sensors through a plurality of readout lines; and
an optical sensor driver configured to sequentially provide a plurality of scan read signals to the plurality of optical sensors from an upper side of the display area to a lower side of the display area through a plurality of scan read lines,
wherein, during a readout period, the readout circuit reads out detection voltages from the plurality of optical sensor through the plurality of readout lines while the optical sensor driver supplies the scan read signals to optical sensors corresponding to a touch input applied to the display area.

2. The display device of claim 1, wherein the optical sensor driver outputs the scan read signals during at least a part of the readout period.

3. The display device of claim 2, wherein, upon detecting the touch input during an idle period, the display device performs an optical sensing operation associated with the touch input, in which the optical sensing operation is performed during a sensing period comprising a reset period, a light receiving period, and the read out period, wherein, during the reset period, the plurality of optical sensors are reset, during the light receiving period, the optical sensors corresponding to the touch input receive light supplied from the plurality of pixels, and the light receiving period is positioned between the reset period and the readout period.

4. The display device of claim 3, wherein, when the touch input is applied to a lower side of the display area, the optical sensor driver outputs a first scan read signal of the plurality of scan read signals prior to the readout period.

5. The display device of claim 4, wherein, a wait period is positioned between the idle period and the reset period, in which the reset period is delayed by the wait period after the idle period, and the optical sensor driver outputs the first scan read signal during the wait period and further outputs remaining scan read signals sequentially during the wait period, the reset period, the light receiving period, and the readout period.

6. The display device of claim 3, wherein, when the touch input is applied to an upper side of the display area, the optical sensor driver outputs a first scan read signal of the plurality of scan read signals during the readout period.

7. The display device of claim 6, wherein the optical sensor driver outputs remaining scan read signals of the plurality of scan read signals sequentially during the reset period, the light receiving period, and the readout period of next sensing period.

8. The display device of claim 3, wherein, the display area includes a first sub-display area and a second sub-display area, in which the first sub-display area is positioned in the upper side of the display area, and the second sub-display area is positioned in the lower side of the display area, wherein the optical sensor driver comprises a first optical sensor driver configured to drive the optical sensors of the first sub-display area and a second optical sensor driver configured to drive the optical sensors of the second sub-display area, and wherein, the first optical sensor driver sequentially outputs a plurality of upper scan read signals of the plurality of scan read signals and the second optical sensor driver sequentially outputs a plurality of lower scan read signals of the plurality of scan read signals.

9. The display device of claim 8, wherein, when the touch input is applied to the second sub-display area, the second optical sensor driver outputs a first lower scan signal of the plurality of lower scan read signals before start of the readout period.

10. The display device of claim 9, wherein the second optical sensor driver sequentially outputs remaining lower scan read signals of the plurality of lower scan read signals during the reset period, the light receiving period, and the readout period.

11. The display device of claim 8, wherein when the touch input applied to the first sub-display area, the first optical sensor driver outputs a first upper scan read signal of the plurality of upper scan read signals during the readout period.

12. The display device of claim 11, wherein the first optical sensor driver sequentially outputs remaining upper scan read signals of the plurality of upper scan read signals during the readout period, and during a reset period and a light receiving period of next sensing period.

13. The display device of claim 12, wherein, when the touch input is positioned to overlap an interface between the first sub-display area and the second sub-display area, the first optical sensor driver sequentially outputs the plurality of upper scan read signals during the reset period, the light receiving period, and a former half of the readout period, and the second optical sensor driver sequentially outputs the plurality of lower scan read signals during a latter half of the readout period, and during a reset period and a light receiving period of next sensing period.

14. The display device of claim 8, further comprising a carry transistor connected between the first optical sensor driver and the second optical sensor driver, and configured to be turned on in response to a carry control signal received from a timing controller, wherein a last upper scan signal of the plurality of upper scan read signals outputted from the first optical sensor driver is provided to the second optical sensor driver by turning on the carry transistor, and the second optical sensor driver outputs a first lower scan read signal of the plurality of lower scan read signals based on the last upper scan read signal.

15. The display device of claim 3, wherein the optical sensor driver sequentially outputs a plurality of scan read signals having different frequencies, the plurality of scan read signals comprising a first-frequency scan read signals and a second-frequency scan read signals having a higher frequency than the first-frequency scan read signals, wherein the optical sensor driver sequentially supplies the first-frequency scan read signals to the optical sensors corresponding to the touch input, while supplying the second-frequency scan read signals to the optical sensors not corresponding to the touch input.

16. The display device of claim 15, wherein during the readout period, the optical sensor driver sequentially outputs the first-frequency scan read signals, and during the reset period and the light receiving period, the optical sensor driver sequentially outputs the second-frequency scan read signals.

17. The display device of claim 1, further comprising a timing controller configured to provide an optical sensor control signal to the optical sensor driver for controlling a driving timing of the optical sensor driver, wherein the optical sensor control signal includes a first clock signal and a second clock signal used for generating the plurality scan read signals, and the first clock signal and the second clock signal have different phases from each other.

18. The display device of claim 17, wherein the photoelectric conversion element comprises a first photoelectric conversion element and a second photoelectric conversion element that are configured to be alternately activated, wherein the first clock signal is applied to the optical sensor driver for generating the plurality scan read signals while the first photoelectric conversion element is activated, and the second clock signal is applied to the optical sensor driver while the second photoelectric conversion element is activated.

19. An electronic device comprising:
a processor; and
a display device providing a display screen,
wherein the display device comprises:
a display panel comprising a display area and a non-display area;
a plurality of pixels and a plurality of optical sensors located in the display area;
a plurality of light emitting elements included in the plurality of pixels;
a scan driver connected to the plurality of pixels and the plurality of optical sensors;
a readout circuit connected to the plurality of optical sensors through a plurality of readout lines; and
an optical sensor driver connected to the plurality of optical sensors and sequentially outputting a plurality of scan read signals to supply the scan read signals to the plurality of optical sensors,
wherein the optical sensor driver provides the scan read signals sequentially to the optical sensors from an upper side of the display area to a lower side of the display area, and
wherein the readout circuit generates digital sensing data based on detection voltages detected from the plurality of optical sensors through the plurality of readout lines during a readout period while the scan read signals are supplied to optical sensors corresponding to a touch input applied to the display area, and transmit the digital sensing data to the processor.

20. The electronic device of claim 19, wherein the processor analyzes the digital sensing data to determine whether the digital sensing data matches a pre-registered user's fingerprint, and when the pre-registered fingerprint and the digital sensing data received from the readout circuit matches, the processor performs preset functions.
